(19) United States
(12) Patent Application Publication
(10) Pub. No.: US 2026/0194735 A1
(43) Pub. Date: Jul. 9, 2026

(54) OPTICAL SYSTEM AND IMAGE PICKUP APPARATUS

(71) Applicant: CANON KABUSHIKI KAISHA, Tokyo (JP)

(72) Inventor: Natsuki ABE, Tochigi (JP)

(21) Appl. No.: 19/434,211

(22) Filed: Dec. 29, 2025

(30) Foreign Application Priority Data
Jan. 8, 2025 (JP) 2025-002958

(51) Int. Cl. G02B 13/00

(52) U.S. Cl. CPC G02B 13/006

(57) ABSTRACT

An optical system consisting of, in order from object side, a positive first lens unit, a stop, and a positive second lens unit, in which the first lens unit consists of first and second subunits, the first subunit includes a positive first lens and a negative second lens, the second subunit consists of a positive third lens and a negative fourth lens, the second lens unit includes a negative fifth lens, a positive sixth lens and plural lenses, a total number of lenses in the optical system is 10 or less, an air gap on optical axis between the first and second lens units is larger than a sum of air gaps between lenses of the second lens unit in infinity focus state, a focal length of the optical system, Petzval sum of the second lens, and average Abbe number of the fourth and fifth lenses are appropriately set.

### BACKGROUND

### Field of the Technology

The disclosure relates to an optical system and an image pickup apparatus.

### Description of the Related Art

In recent years, it has been strongly desired that an optical system used in an image pickup apparatus has a large aperture ratio, but the entire lens system is compact, and has high optical performance.

An image pickup optical system called a double Gaussian type is known as a lens having a standard angle of view with a maximum image pickup half angle of view of about 20 degrees to 30 degrees. Japanese Patent Publication No. S39-10178 discloses an image pickup optical system having a small size and a large aperture ratio, which includes, in order from an object side to an image side, a front unit having a positive refractive power, an aperture stop, and a rear unit having a positive refractive power.

In a double Gaussian image pickup optical system, in order to satisfactorily correct the curvature of field, it is necessary to increase the refractive index of the entire positive lens and reduce the value of the Petzval sum with respect to the entire optical system. However, in this case, correction of the chromatic aberration becomes difficult because a lens glass material having a high refractive index generally has high dispersion characteristics.

### SUMMARY

The disclosure is to provide an optical system which has a large aperture ratio, has a small lens system as a whole, satisfactorily corrects various aberrations including chromatic aberration, and has high optical performance.

According to one aspect of the disclosure, an optical system includes, in order from an object side to an image side, a first lens unit having a positive refractive power, an aperture stop, and a second lens unit having a positive refractive power, in which the first lens unit includes, in order from the object side to the image side, a first subunit and a second subunit, in which the first subunit includes, in order from the object side to the image side, a first lens having a positive refractive power and a second lens having a negative refractive power, in which the second subunit includes, in order from the object side to the image side, a third lens having a positive refractive power and a fourth lens having a negative refractive power, in which the second lens unit includes, in order from the object side to the image side, a fifth lens having a negative refractive power, a sixth lens having a positive refractive power, and two or more lenses, in which a total number of lenses disposed in the optical system is 10 or less, in which a total number of lens units disposed in the optical system is two, in which a total number of subunits disposed in the first lens unit is two, in which a total number of lenses disposed in the second subunit is two, in which in an infinity focus state, an air gap on an optical axis between the first lens unit and the second lens unit is larger than a sum of air gaps between lenses included in the second lens unit, and in which the following inequalities are satisfied,

$$- 1. \leq f \times PL 2 \leq - 0 \text{.15}$$

$$15. 00 \leq vdL 45 \leq 32.00$$

where f represents a focal length of an entire system of the optical system, PL2 represents a Petzval sum of the second lens, and vdL45 represents an average value of Abbe numbers of the fourth lens and the fifth lens.

According to another aspect of the disclosure, an optical system includes, in order from an object side to an image side, a first lens unit having a positive refractive power, an aperture stop, and a second lens unit having a positive refractive power, in which the first lens unit includes, in order from the object side to the image side, a first subunit and a second subunit, in which the first subunit includes, in order from the object side to the image side, a first lens having a positive refractive power and a second lens having a negative refractive power, in which the second subunit includes, in order from the object side to the image side, a third lens having a positive refractive power and a fourth lens having a negative refractive power, in which the second lens unit includes, in order from the object side to the image side, a fifth lens having a negative refractive power, a sixth lens having a positive refractive power, and two or more lenses, in which a total number of lenses disposed in the optical system is 10 or less, in which a total number of lens units disposed in the optical system is two, in which a total number of subunits disposed in the first lens unit is two, in which a total number of lenses disposed in the second subunit is two, and in which the following inequalities are satisfied,

$$- 0.61 \leq f \times PL 2 \leq - 0 \text{.15}$$

$$15. 00 \leq vdL 45 \leq 27.50$$

where f represents a focal length of an entire system of the optical system, PL2 represents a Petzval sum of the second lens, and vdL45 represents an average value of Abbe numbers of the fourth lens and the fifth lens.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view of an optical system according to Embodiment 1 in a state of being focused on infinity.

FIG. 2 is an aberration diagram of the optical system of Embodiment 1 in a state of being focused on infinity.

FIG. 3 is a cross-sectional view of an optical system according to Embodiment 2 in a state of being focused on infinity.

FIG. 4 is an aberration diagram of the optical system of Embodiment 2 in a state of being focused on infinity.

FIG. 5 is a cross-sectional view of an optical system according to Embodiment 3 in a state of being focused on infinity.

FIG. 6 is an aberration diagram of the optical system of Embodiment 3 in a state of being focused on infinity.

FIG. 7 is a cross-sectional view of an optical system according to Embodiment 4 in a state of being focused on infinity.

FIG. 8 is an aberration diagram of the optical system of Embodiment 4 in a state of being focused on infinity.

FIG. 9 is a cross-sectional view of an optical system according to Embodiment 5 in a state of being focused on infinity.

FIG. 10 is an aberration diagram of the optical system of Embodiment 5 in a state of being focused on infinity.

FIG. 11 is a cross-sectional view of an optical system according to Embodiment 6 in a state of being focused on infinity.

FIG. 12 is an aberration diagram of the optical system of Embodiment 6 in a state of being focused on infinity.

FIG. 13 is a cross-sectional view of an optical system according to Embodiment 7 in a state of being focused on infinity.

FIG. 14 is an aberration diagram of the optical system of Embodiment 7 in a state of being focused on infinity.

FIG. 15 is a cross-sectional view of an optical system of Embodiment 8 in a state of being focused on infinity.

FIG. 16 is an aberration diagram of the optical system of Embodiment 8 in a state of being focused on infinity.

FIG. 17 is a cross-sectional view of the optical system of Embodiment 9 in a state of being focused on infinity.

FIG. 18 is an aberration diagram of the optical system of Embodiment 9 in a state of being focused on infinity.

FIG. 19 is a diagram schematically illustrating an image pickup apparatus.

FIG. 20 is a diagram schematically illustrating a lens apparatus.

### DESCRIPTION OF THE EMBODIMENTS

Hereinafter, Embodiments of the disclosure will be described with reference to the drawings. First, prior to the description of specific Embodiments 1 to 9, matters common to the respective Embodiments will be described.

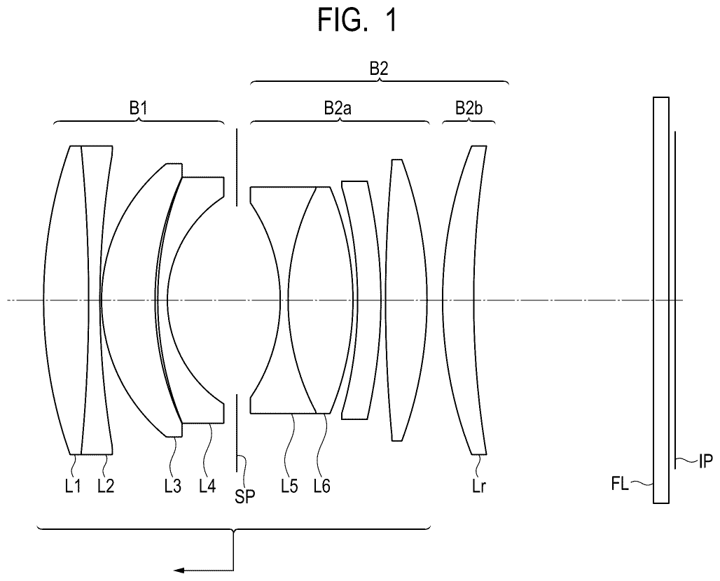

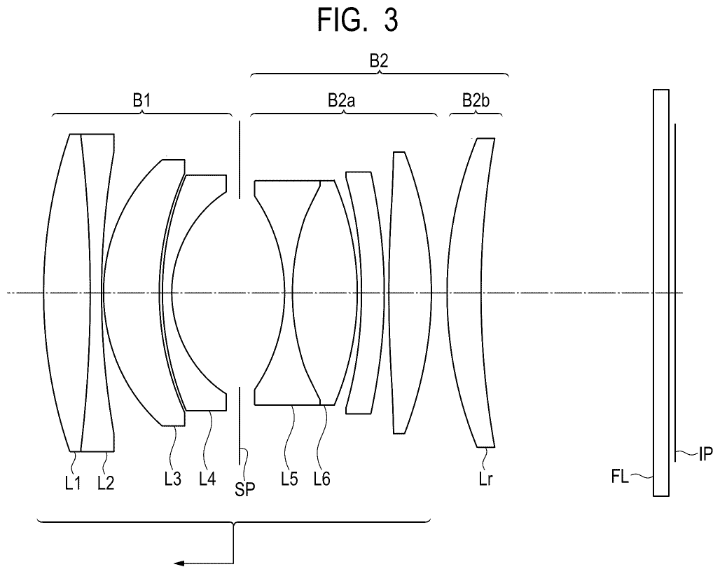

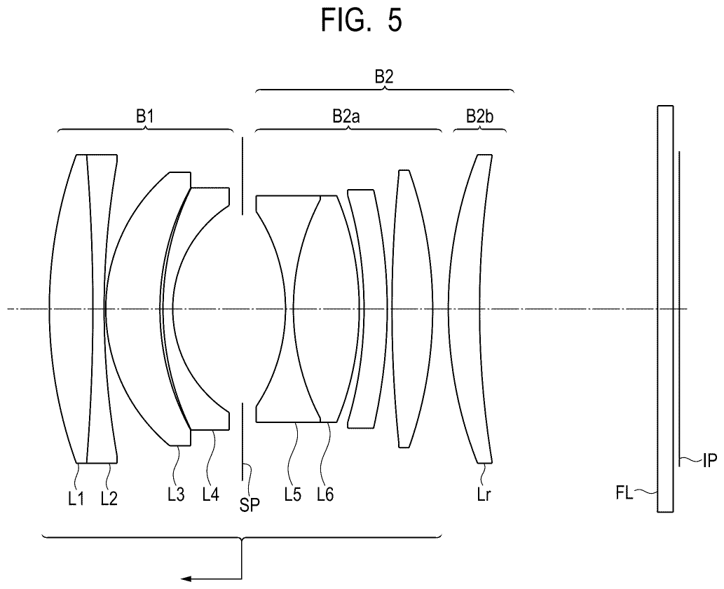

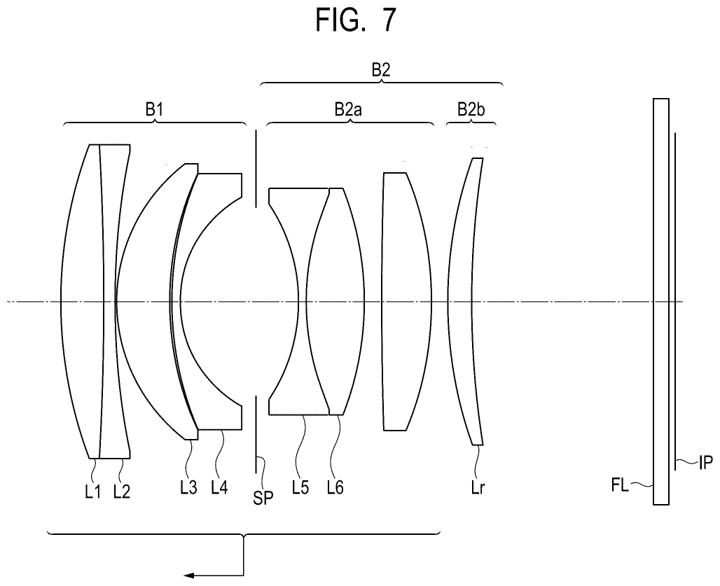

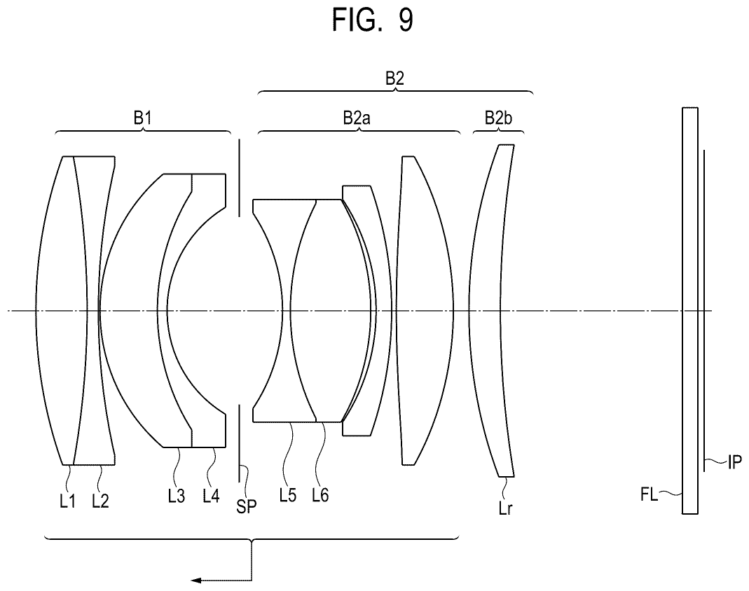

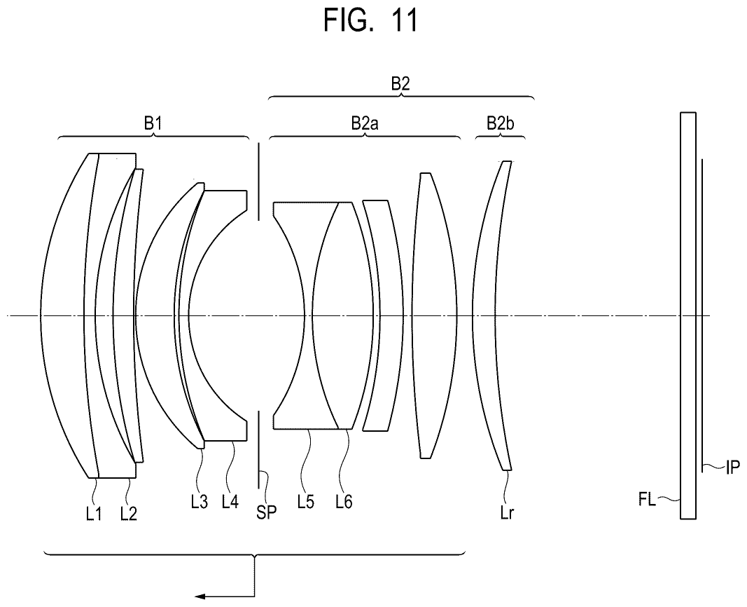

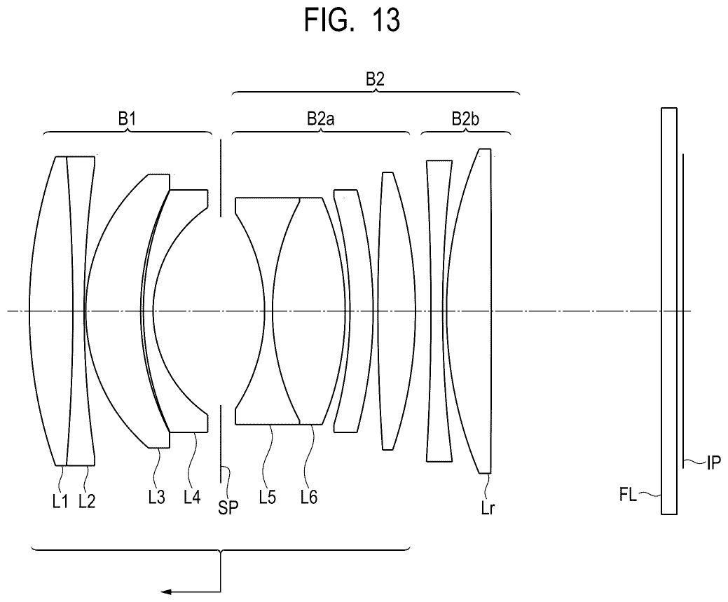

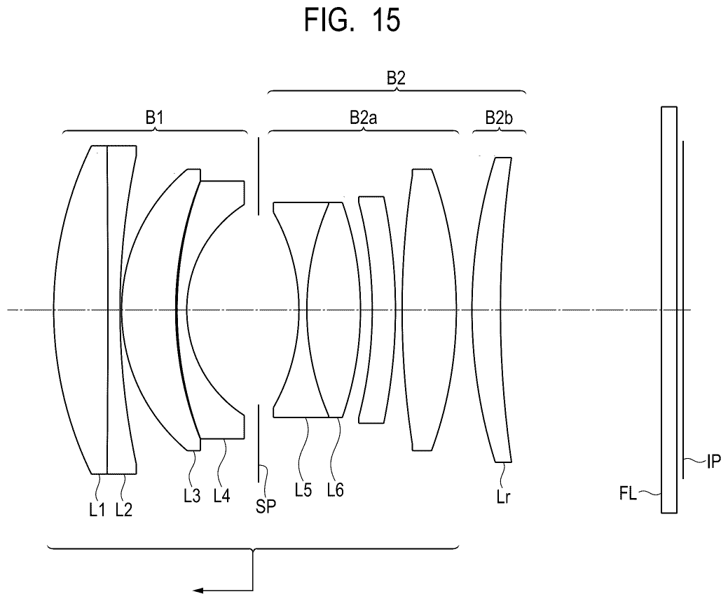

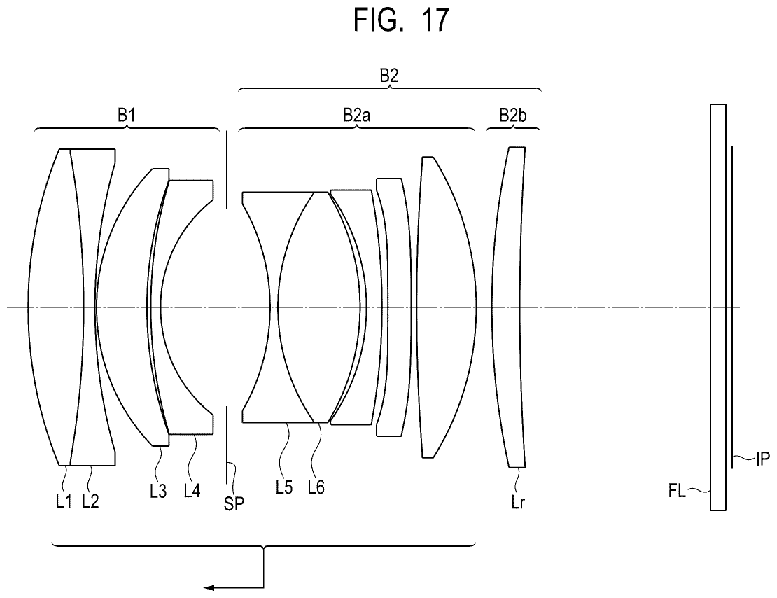

FIGS. 1, 3, 5, 7, 9, 11, 13, 15, and 17 are cross-sectional views of the optical systems of Embodiments 1 to 9 in a state of being focused on an object at infinity. In each cross-sectional view, SP denotes an aperture stop, FL denotes an optical block corresponding to an optical filter, a face plate, a quartz low-pass filter, an infrared cut filter, or the like, and IP denotes an image plane. An image pickup surface (light receiving surface) of the image pickup element or a film surface (photosensitive surface) of a silver halide film is disposed on the image plane IP.

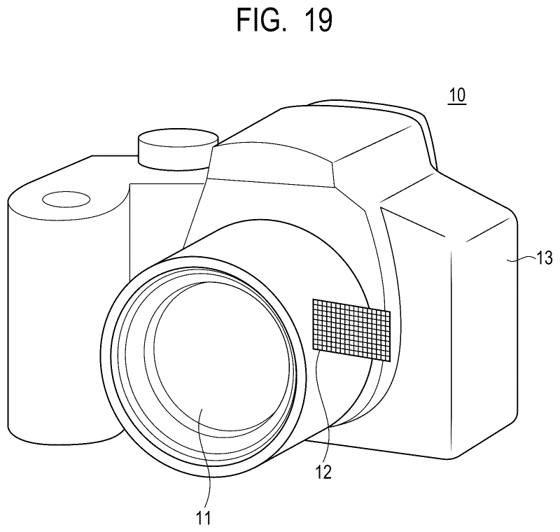

FIG. 19 schematically illustrates an image pickup apparatus including the optical system of any of Embodiments 1 to 9.

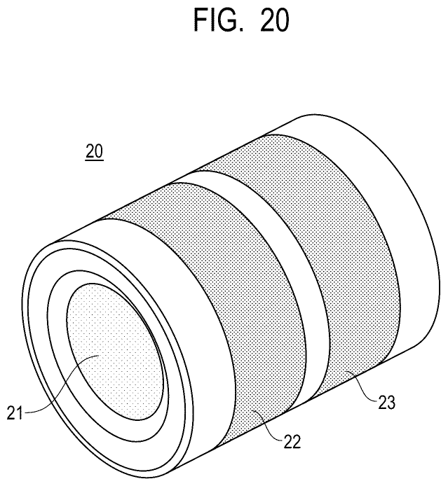

FIG. 20 schematically shows a lens apparatus including the optical system of any of Embodiments 1 to 9.

The optical system of each Embodiment includes, in order from the object side to the image side, a first lens unit B1 having a positive refractive power, an aperture stop SP, and a second lens unit B2 having a positive refractive power. The optical system of the disclosure has such a configuration, so that a double Gaussian symmetrical lens arrangement is achieved an excellent aberration correction effect is obtained, and the optical system is suitable for image pickup apparatuses such as a digital video camera, a digital still camera, a broadcasting camera, a silver-halide film camera, and a monitoring camera.

The first lens unit B1 includes a first subunit and a second subunit, which are arranged in order from the object side to the image side. The first subunit includes, in order from the object side to the image side, a first lens L1 having a positive refractive power and a second lens L2 having a negative refractive power. With such a configuration, the object side surface of the first lens L1 and the image side surface of the second lens L2 have a shape that is concentric with respect to the aperture stop SP, and the occurrence of off-axis aberration can be suppressed. The second subunit includes, in order from the object side to the image side, a third lens having a positive refractive power and a fourth lens L4 having a negative refractive power.

The second lens unit B2 includes, in order from the object side to the image side, a fifth lens L5 having a negative refractive power and a sixth lens L6 having a positive refractive power. By adopting such a double Gaussian lens arrangement, a favorable correction effect of coma, distortion aberration, and chromatic aberration of magnification can be obtained by adopting a lens arrangement symmetrical with respect to the aperture stop SP while giving a strong spherical aberration correction effect to the air lens located at the position of the aperture stop SP.

The second lens unit B2 includes two or more positive lenses on the image side of the sixth lens L6. With such a configuration in which two positive lenses are disposed closest to the image side in the double Gaussian configuration, a concave air lens is provided in the second lens unit B2, and a high-order coma aberration can be satisfactorily corrected by a strong positive power effect on the off-axis light.

The second lens unit B2 includes a second-a lens unit B2a that moves on the optical axis integrally with the first lens unit B1 and the aperture stop SP at the time of focusing, and a second-b lens unit B2b that does not move relative to the image plane IP at the time of focusing. As described above, by arranging the lens unit which does not move relative to the image plane IP closest to the image side, it is possible to suppress the spherical aberration fluctuation and the aberration fluctuation in curvature of field at the time of focusing.

In the optical system of each Embodiment, the total number of lenses is 10 or less as a whole, and the sum of the air intervals on the optical axis between the lenses included in the second lens unit B2 in a state of being focused on infinity is smaller than the air interval on the optical axis between the first lens unit B1 and the second lens unit B2. With such a configuration, it is possible to realize a large aperture by a satisfactory spherical aberration correction effect due to the strong negative power of the air lens located at the position of the aperture stop SP, and to maximize the advantage of the double Gaussian lens.

The first lens L1 and the second lens L2 are cemented to each other to constitute a cemented lens. This cemented lens has an object-side surface which has a convex shape and a meniscus shape having a positive refractive power. With such a configuration, the object side surface and the image side surface of the cemented lens have shapes that are concentric with respect to the aperture stop SP, and it is possible to provide each lens with strong power while suppressing the occurrence of off-axis aberration, and it is possible to obtain a satisfactory correction effect of chromatic aberration of magnification.

The fifth lens L5 and the sixth lens L6 are cemented with each other to constitute a cemented lens. With such a configuration, an excellent correction effect of the axial chromatic aberration can be obtained.

The maximum image pickup half angle of view of each optical system is about 20 degrees to 30 degrees. Such a standard angle-of-view lens specification is known as an angle-of-view range in which, in a double Gaussian lens configuration, it is possible to provide a strong negative power to the air lens located at the aperture stop SP while maintaining a concentric lens shape centered on the aperture stop SP. Accordingly, it is possible to realize satisfactory correction of spherical aberration and suppression of generation of off-axis aberration, and to achieve both a large aperture ratio with an F-number of about 1.2 and satisfactory aberration correction in each optical system.

In addition, in each optical system, distortion aberration having a negative sign remains due to the effect of reducing the lens diameter. Therefore, in the image pickup apparatus including the optical system of the disclosure, the remaining distortion aberration is corrected on software by electronic correction processing, so that it is possible to realize both downsizing of the optical system and correction of the distortion aberration.

At the time of focusing from an infinity in-focus state to a short-distance object, the subunit including the first lens unit B1, the aperture stop SP, and the second-a lens unit B2a integrally moves on the optical axis toward the object side, and the second-b lens unit B2b does not move with respect to the image plane IP. In each of the drawings, a solid arrow indicates a moving direction of the subunit at the time of focusing from an infinity in-focus state to a short-distance object.

Further, in the optical system of each Embodiment, the following inequalities (1) and (2) are satisfied,

$$- 1. \leq f \times PL 2 \leq - 0.15 \qquad ( 1 )$$

$$15. 00 \leq vdL 45 \leq 32.00 \qquad ( 2 )$$

where f represents a focal length of the entire system of the optical system, PL2 represents a Petzval sum with respect to the second lens L2, and vdL45 represents an average value of Abbe numbers with respect to the d-line of the fourth lens L4 and the fifth lens L5.

Here, the Petzval sum PL2 is defined as,

$$PL 2 = 1 / ( NdL 2 \times fL 2 )$$

where NdL2 represents the refractive index of the second lens L2 and fL2 represents a focal length of the second lens L2.

The inequality (1) indicates an appropriate range of the product of the focal length of the entire system of the optical system and the Petzval sum with respect to the second lens L2. If PL2 is increased so that f×PL2 exceeds the upper limit of the inequality (1), the power of the second lens L2 becomes strong, the symmetric power arrangement of the double Gaussian type is lost, and it becomes difficult to correct the coma and the distortion, which is not preferable. When f×PL2 becomes smaller than the lower limit of the inequality (1), the Petzval sum with respect to the entire optical system becomes large, and it becomes difficult to correct the curvature of field, which is not preferable.

The inequality (2) indicates an appropriate range of the average value vdL45 of the Abbe numbers of the fourth lens L4 and the fifth lens L5. If the Abbe numbers of the fourth lens L4 and the fifth lens L5 are increased so that vdL45 exceeds the upper limit of the inequality (2), it becomes difficult to correct the axial chromatic aberration and the chromatic aberration of magnification, which is not preferable. If the Abbe numbers of the fourth lens L4 and the fifth lens L5 are decreased so that vd45 is below the lower limit of the inequality (2), the refractive indexes of the fourth lens L4 and the fifth lens L5 are generally increased due to the high refractive index of the high dispersion glass material, the Petzval sum with respect to the entire optical system is increased, and it is difficult to correct the curvature of field, which is not preferable.

Further, it is more preferable to set the numerical ranges of the inequalities (1) and (2) as follows.

$$- 0.87 \leq f \times PL 2 \leq - 0 \text{.17} \qquad ( 1 a )$$

$$16.47 \leq vdL 45 \leq 31.47 \qquad ( 2 a )$$

Further, it is more preferable to set the numerical ranges of the inequalities (1) and (2) as follows.

$$- 0.74 \leq f \times PL 2 \leq - 0 \text{.19} \qquad ( 1 b )$$

$$17.94 \leq vdL 45 \leq 30.93 \qquad ( 2 b )$$

Further, it is more preferable to set the numerical ranges of the inequalities (1) and (2) as follows.

$$- 0.61 \leq f \times PL 2 \leq - 0.21 \qquad ( 1 c )$$

$$19.41 \leq vdL 45 \leq 27.50 \qquad ( 2 c )$$

By having the above-described configuration and satisfying the inequalities (1) and (2), it is possible to provide an optical system in which the entire lens system is small in size, various aberrations including the chromatic aberration are satisfactorily corrected, and high optical performance is obtained whereas having a large aperture ratio, and an image pickup apparatus including the optical system.

In the optical system of each Embodiment, the following inequality (3) is satisfied,

$$- 0.28 \leq fSP / f \leq - 0.12 \qquad ( 3 )$$

where fSP represents a focal length of the air lens at the position of the aperture stop SP between the first lens unit B1 and the second lens unit B2 at the time of being focused on infinity.

Note that fSP is obtained as follows,

$$fSP = \frac{1}{\frac{1 - NdL 4}{R 2 L 4} - \frac{1 - NdL 5}{R 1 L 5} + \frac{( 1 - NdL 4 ) \times ( 1 - NdL 5 ) \times TSP}{R 2 L 4 \times R 1 L 5}} \qquad ( a )$$

where NdL4 and NdL5 represent refractive indices of the fourth lens L4 and the fifth lens L5 with respect to the d-line, respectively, R2L4 represents a curvature radius of an image-side surface of the fourth lens L4, R1L5 represents a curvature radius of an object-side surface of the fifth lens L5, and TSP represents an air gap between the first lens unit B1 and the second lens unit B2 on the optical axis.

The inequality (3) indicates an appropriate range of the ratio of the focal length fSP of the air lens located at the position of the aperture stop SP to the focal length of the entire system of the optical system. If fSP is increased so that fSP/f exceeds the upper limit of the inequality (3), a satisfactory spherical aberration correction effect by the air lens cannot be obtained, and it becomes difficult to realize a large aperture ratio, which is not preferable. If fSP/f becomes smaller than the lower limit of the inequality (3), the radius of curvature of each surface of the air lens becomes smaller, and it becomes difficult to suppress sagittal coma flare generated in the air lens, which is not preferable.

In the optical system of each Embodiment, the following inequality (4) is satisfied,

$$0.18 \leq TSP / TD \leq 0.33 \qquad ( 4 )$$

where TRD represents a distance on the optical axis between a surface closest to the object side and a surface closest to the image side of the optical system.

The inequality (4) indicates an appropriate range of the ratio of the air gap on the optical axis between the first lens unit B1 and the second lens unit B2 to the total lens length of the optical system. If the TSP is increased so that the TSP/TD exceeds the upper limit of the inequality (4), the entire optical system becomes large, which is not preferable. If TSP becomes smaller so that TSP/TD becomes lower than the lower limit of the inequality (4), the lens surfaces on the object side and on the image side of the aperture stop SP are formed into a concentric shape centered on the aperture stop SP in order to suppress the occurrence of off-axis aberrations, so that the radius of curvature of the surface becomes smaller, and it becomes difficult to suppress the sagittal coma flare, which is not preferable.

In the optical system of each Embodiment, the following inequality (5) is satisfied

$$0.72 \leq ( T B 1 + TB 2 ) / f \leq 1.12 \qquad ( 5 )$$

where TB1 represents a distance between a surface closest to the object side and a surface closest to the image side of the first lens unit B1 on the optical axis, and TB2 represents a distance between a surface closest to the object side and a surface closest to the image side of the second lens unit B2 on the optical axis.

The inequality (5) indicates an appropriate range of the ratio of a sum of a thickness of the first lens unit B1 on the optical axis and a thickness of the second lens unit B2 on the optical axis to the focal length of the entire system of the optical system. If (TB1+TB2) is increased so that (TB1+TB2)/f exceeds the upper limit of the inequality (5), the entire length of the optical system is increased, and the entire optical system becomes large, which is not preferable. If (TB1+TB2) is decreased so that (TB1+TB2)/f is less than the lower limit of inequality (5), the curvature radius of each lens becomes small due to the need for strong divergence and convergence of light beams, and suppression of high-order aberration becomes difficult, which is not preferable.

In the optical system of each embodiment, it is preferable to satisfy the following inequality (6),

$$0.42 \leq Sk / f \leq 0.60 \qquad ( 6 )$$

where Sk represents the back focus of the optical system.

The inequality (6) indicates an appropriate range of a ratio of the back focus of the optical system to the focal length of the entire system of the optical system. If Sk increases so that Sk/f exceeds the upper limit of the inequality (6), the entire length of the optical system increases, and the entire optical system becomes large, which is not preferable. If Sk/f becomes smaller than the lower limit of the inequality (6), the power of the first lens unit B1 becomes stronger, the symmetrical power arrangement of the double Gaussian type is lost, and it becomes difficult to correct the coma and the distortion, which is not preferable.

In the optical system of each Embodiment, it is preferable to satisfy the following inequality (7),

$$1.77 \leq NdLp \leq 1.97 \qquad ( 7 )$$

where NdLp represents an average value of the refractive indices of all the positive lenses included in the optical system with respect to the d-line.

The inequality (7) indicates an appropriate range of the average value of the refractive indexes of all the positive lenses included in the optical system. If NdLp becomes larger than the upper limit of the inequality (7), the Abbe number of the positive lens decreases due to the high dispersion of the lens material having a high refractive index, and it becomes difficult to correct the axial chromatic aberration and the chromatic aberration of magnification, which is not preferable. If NdLp becomes smaller than the lower limit of the inequality (7), the Petzval sum with respect to the entire optical system becomes large, and it becomes difficult to correct the curvature of field, which is not preferable.

In the optical system of each Embodiment, it is preferable to satisfy the following inequality (8),

$$- 3.10 \leq f \times PL 245 \leq - 2.21 \qquad ( 8 )$$

where PL245 represents a Petzval sum of the second lens L2, the fourth lens L4, and the fifth lens L5.

Note that PL245 is obtained as follows,

$$PL 245 = \frac{1}{NdL 2 \times fL 2} + \frac{1}{NdL 4 \times fL 4} + \frac{1}{NdL 5 \times fL 5} \qquad ( b )$$

where NdL2, NdL4, and NdL5 represent refractive indices of the second lens L2, the fourth lens L4, and the fifth lens L5 with respect to the d-line, respectively, and fL2, fL4, and fL5 represent focal lengths of the second lens L2, the fourth lens L4, and the fifth lens L5, respectively.

The inequality (8) indicates an appropriate range of a product of the focal length of the entire system of the optical system and the Petzval sum of the second lens L2, the fourth lens L4, and the fifth lens L5. If f×PL245 becomes larger than the upper limit of inequality (8), the Petzval sum of the entire optical system becomes large, and it becomes difficult to correct the curvature of field, which is not preferable. If f×PL245 becomes smaller than the lower limit of the inequality (8), the Abbe numbers of the second lens L2, the fourth lens L4, and the fifth lens L5 become large due to the low dispersion of the lens material having a low refractive index, and it becomes difficult to correct chromatic aberration generated in the positive lens, which is not preferable.

In the optical system of each Embodiment, it is preferable to satisfy the following inequality (9),

$$0. 23 \leq fB 1 B 2 a / fB 2 b \leq 0.56 \qquad ( 9 )$$

where fB1B2a represents a combined focal length of the first lens unit B1 and the second-a lens unit B2a, and fB2b represents a focal length of the second-b lens unit B2b.

The inequality (9) indicates an appropriate range of a ratio of the combined focal length of the first lens unit B1 and the second-a lens unit B2a which move at the time of focusing to the focal length of the second-b lens unit B2b which does not move with respect to the image plane IP at the time of focusing. If fB1B2a is increased so that fB1B2a/fB2b exceeds the upper limit of the inequality (9), a moving distance of the movable lens unit at the time of focusing is increased, and it is difficult to quickly and silently drive focusing, which is not preferable. If fB1B2a becomes smaller so that fB1B2a/fB2b becomes smaller than the lower limit of inequality (9), it becomes difficult to suppress the spherical aberration fluctuation at the time of focusing, which is not preferable.

In the optical system of each Embodiment, it is preferable to satisfy the following inequality (10),

$$- 2.80 \leq SFL 2 \leq 0.62 \qquad ( 10 )$$

where SFL2 represents a value of a shape factor of the second lens L2.

Note that SFL2 is defined as,

$$SFL 2 = ( R 2 L 2 + R 1 L 2 ) / ( R 2 L 2 - R 1 L 2 ) \qquad ( c )$$

where R1L2 and R2L2 represent curvature radii of the object side surface and the image side surface of the second lens L2, respectively.

The inequality (10) indicates an appropriate range of the value of the shape factor of the second lens L2. If SFL2 becomes larger than the upper limit of inequality (10), an angle of light beams incident on the object-side surface of the second lens L2 becomes large, and it becomes difficult to suppress off-axis aberrations, which is not preferable. If SFL2 becomes smaller than the lower limit of the inequality (10), it becomes difficult to avoid a total reflection ghost having a strong intensity that is likely to be generated in a double Gaussian optical system, which is not preferable.

In the optical system of each embodiment, it is preferable to satisfy the following inequality (11),

$$- 0.08 \leq SFLr \leq 4.55 \qquad ( 11 )$$

where SFLr represents a value of the shape factor of a rear lens Lr that is disposed closest to the image side in the optical system.

Note that SFLr is defined as,

$$SFLr = ( R 2 Lr + R 1 Lr ) / ( R 2 Lr - R 1 Lr ) \qquad ( d )$$

where R1Lr and R2Lr represent curvature radii of the object side surface and the image side surface of the rear lens Lr, respectively.

The inequality (11) indicates an appropriate range of a value of the shape factor of the rear lens Lr. If SFLr becomes larger than the upper limit of the inequality (11), multiple reflection occurs between the image plane IP and the rear lens Lr, and it becomes difficult to avoid ghost with high imaging performance, which is not preferable. If SFLr becomes smaller than the lower limit of the inequality (11), it becomes difficult to suppress the coma and the curvature of field at the time of focusing, which is not preferable.

In the optical system of each embodiment, it is preferable to satisfy the following inequality (12),

$$1.5 \leq TL / f \leq 2.02 \qquad ( 12 )$$

where TL represents a distance (total optical length) between a lens surface closest to the object side of the optical system and the image plane IP on the optical axis.

The inequality (12) indicates an appropriate range of a ratio of the total optical length of the optical system to the focal length of the entire system of the optical system. If TL is increased so that TL/f exceeds the upper limit of the inequality (12), the entire length of the optical system increases, and the entire optical system becomes large, which is not preferable. If TL/f becomes smaller so as to fall below the lower limit of the inequality (12), the radius of curvature of each lens becomes smaller due to the need for a strong divergence and convergence action of light beams, and it becomes difficult to suppress high-order aberrations, which is not preferable.

In the optical system of each Embodiment, it is preferable to satisfy the following inequality (13),

$$2.07 \leq fB 1 / fB 2 \leq 4.93 \qquad ( 13 )$$

where fB1 represents a focal length of the first lens unit B1 and fB2 represents a focal length of the second lens unit B2.

The inequality (13) indicates an appropriate range of a ratio of the focal length of the first lens unit B1 to the focal length of the second lens unit B2. If fB1 is increased so that fB1/fB2 exceeds the upper limit of the inequality (13), the back focus of the optical system is enlarged and the entire optical system becomes large, which is not preferable. If fB1 is decreased so that fB1/fB2 becomes smaller than the lower limit of the inequality (13), the symmetric power arrangement of the double Gaussian type is lost, and it becomes difficult to correct the coma and the distortion, which is not preferable.

In the optical system of each Embodiment, it is preferable to satisfy the following inequality (14),

$$0.31 \leq fL 1 L 2 / fB 1 \leq 1.98 \qquad ( 14 )$$

where fL1L2 represents a combined focal length of the first lens L1 and the second lens L2.

The inequality (14) indicates an appropriate range of a ratio of the combined focal length of the first lens L1 and the second lens L2 to the focal length of the first lens unit B1. If fL1L2 increases so that fL1L2/fB1 exceeds the upper limit of the inequality (14), an angle of a light beam incident on a lens disposed adjacent to the image side of the second lens L2 increases, and it becomes difficult to correct the high-order coma, which is not preferable. If fL1L2 becomes smaller such that fL1L2/fB1 becomes smaller than the lower limit of the inequality (14), a convergence effect of the light beam becomes weak, and the entire optical system becomes large, which is not preferable.

In the optical system of each Embodiment, it is preferable to satisfy the following inequality (15),

$$- 1.2 \leq fL 5 / fL 6 \leq - 0.64 \qquad ( 15 )$$

where fL5 represents a focal length of the fifth lens L5 and fL6 represents a focal length of the sixth lens L6.

The inequality (15) indicates an appropriate range of a ratio of a focal length of the fifth lens L5 to a focal length of the sixth lens L6. If fL5 is increased so that fL5/fL6 exceeds the upper limit of inequality (15), the first-order axial chromatic aberration is insufficiently corrected, which is not preferable. If fL5 becomes smaller so that fL5/fL6 becomes lower than the lower limit of the inequality (15), the primary axial chromatic aberration is excessively corrected, which is not preferable.

In the optical system of each Embodiment, it is preferable to satisfy the following inequality (16),

$$18. \leq ω \leq 32. \qquad ( 16 )$$

where ω (degrees) represents a maximum image pickup half angle of view.

The inequality (16) indicates an appropriate range of the value of the maximum imaging half angle of view of the optical system. If ω becomes larger than the upper limit of the inequality (16), the symmetric power arrangement of the double Gaussian type is lost due to the widening of the angle of the optical system, and it becomes difficult to correct the coma and the distortion, which is not preferable. If ω becomes smaller than the lower limit of the inequality (16), in a case of adopting a lens shape that is concentric with the aperture stop SP in order to suppress the occurrence of off-axis aberration, the curvature of the lens surfaces on the object side and on the image side of the aperture stop SP becomes loose, and it becomes difficult to satisfactorily correct the spherical aberration in the air lens positioned at the aperture stop SP, which is not preferable.

In the optical system of each embodiment, it is preferable to satisfy the following inequality (17),

$$Fno \leq 2.07 \qquad ( 17 )$$

where Fno represents a F number of the optical system.

The inequality (17) indicates an appropriate range of a value of the F number of the optical system. By satisfying the range of inequality (17), an optical system having a large aperture ratio is realized.

In the optical system of each Embodiment, it is preferable to satisfy the following inequality (18),

$$- 8.47 \leq Di \leq - 3.27 \qquad ( 18 )$$

where Di represents a maximum value of the distortion amount in the central projection method.

The inequality (18) indicates an appropriate range of a value of the distortion amount with respect to the maximum image pickup half angle of view. If Di becomes larger than the upper limit of the inequality (18), the symmetric power arrangement of the double Gaussian type is lost, and it becomes difficult to correct the coma and the chromatic aberration of magnification, which is not preferable. If Di becomes smaller than the lower limit of inequality (18), it becomes difficult to reduce the lens diameter using electronic correction of distortion, which is not preferable.

Further, it is more preferable to set the numerical ranges of the inequalities (3) to (18) as follows.

$$- 0.27 \leq fSP / f \leq - 0 \text{.13} \qquad ( 3 a )$$

$$0.19 \leq TSP / TD \leq 0.32 \qquad ( 4 a )$$

$$0.74 \leq ( TB 1 + TB 2 ) / f \leq 1.10 \qquad ( 5 a )$$

$$0.43 \leq Sk / f \leq 0.59 \qquad ( 6 a )$$

$$1. 78 \leq NdLp \leq 1.96 \qquad ( 7 a )$$

$$- 3.05 \leq f \times PL 245 \leq - 2.26 \qquad ( 8 a )$$

$$0.25 \leq fB 1 B 2 a / fB 2 b \leq 0.54 \qquad ( 9 a )$$

$$- 2.6 \; 1 \leq SFL 2 \leq 0.43 \qquad ( 10 a )$$

$$0.18 \leq SFLr \leq 4.29 \qquad ( 11 a )$$

$$1. 53 \leq TL / f \leq 1.99 \qquad ( 12 a )$$

$$2.23 \leq fB 1 / fB 2 \leq 4.77 \qquad ( 13 a )$$

$$0.4 \leq fL 1 L 2 / fB 1 \leq 1.89 \qquad ( 14 a )$$

$$- 1.1 \; 7 \leq fL 5 / fL 6 \leq - 0.67 \qquad ( 15 a )$$

$$19.12 \leq ω \leq 30.13 \qquad ( 16 a )$$

$$Fno \leq 1.86 \qquad ( 17 a )$$

$$- 8.18 \leq Di \leq - 3.56 \qquad ( 18 a )$$

It is further preferable that the numerical ranges of inequalities (3a) to (18a) be as follows.

$$- 0.26 \leq fSP / f \leq - 0 \text{.14} \qquad ( 3 b )$$

$$0.2 \leq TSP / TD \leq 0.31 \qquad ( 4 b )$$

$$0.76 \leq ( TB 1 + TB 2 ) / f \leq 1.08 \qquad ( 5 b )$$

$$0.44 \leq Sk / f \leq 0.58 \qquad ( 6 b )$$

$$1.79 \leq NdLp \leq 1.95 \qquad ( 7 b )$$

$$- 3. \leq f \times PL 245 \leq - 2.31 \qquad ( 8 b )$$

$$0.27 \leq fB 1 B 2 a / fB 2 b \leq 0.52 \qquad ( 9 b )$$

$$- 2.42 \leq SFL 2 \leq 0.24 \qquad ( 10 b )$$

$$0. 44 \leq SFLr \leq 4.03 \qquad ( 11 b )$$

$$1. 56 \leq TL / f \leq 1.96 \qquad ( 12 b )$$

$$2.39 \leq fB 1 / fB 2 \leq 4.61 \qquad ( 13 b )$$

$$0.49 \leq fL 1 L 2 / fB 1 \leq 1.8 \qquad ( 14 b )$$

$$- 1.1 \; 4 \leq fL 5 / fL 6 \leq - 0.70 \qquad ( 15 b )$$

$$20.24 \leq ω \leq 28.27 \qquad ( 16 b )$$

$$Fno \leq 1.46 \qquad ( 17 b )$$

$$- 7.8 \; 9 \leq Di \leq - 3.85 \qquad ( 18 b )$$

It is further preferable that the numerical ranges of inequalities (3b) to (18b) are as follows.

$$- 0.25 \leq fSP / f \leq - 0 \text{.15} \qquad ( 3 c )$$

$$0.21 \leq TSP / TD \leq 0.30 \qquad ( 4 c )$$

$$0.78 \leq ( TB 1 + TB 2 ) / f \leq 1.06 \qquad ( 5 c )$$

$$0.45 \leq Sk / f \leq 0.57 \qquad ( 6 c )$$

$$1. 80 \leq NdLp \leq 1.94 \qquad ( 7 c )$$

$$- 2.9 \; 5 \leq f \times PL 245 \leq - 2.36 \qquad ( 8 c )$$

$$0.29 \leq fB 1 B 2 a / fB 2 b \leq 0.50 \qquad ( 9 c )$$

$$- 2.23 \leq SFL 2 \leq 0.05 \qquad ( 10 c )$$

$$0.7 \leq SFLr \leq 3.77 \qquad ( 11 c )$$

$$1. 59 \leq TL / f \leq 1.93 \qquad ( 12 c )$$

$$2.55 \leq fB 1 / fB 2 \leq 4.45 \qquad ( 13 c )$$

$$0.58 \leq fL 1 L 2 / fB 1 \leq 1.71 \qquad ( 14 c )$$

$$- 1.1 \; 1 \leq fL 5 / fL 6 \leq - 0.73 \qquad ( 15 c )$$

$$21.36 \leq ω \leq 26.4 \qquad ( 16 c )$$

$$Fno \leq 1.24 \qquad ( 17 c )$$

$$- 7.6 \; 0 \leq Di \leq - 4.14 \qquad ( 18 c )$$

### EMBODIMENTS

Hereinafter, configurations of the optical systems of Embodiments 1 to 9 will be specifically described. First, the configuration of the first lens unit B1 will be described. The first lens unit B1 in Embodiments 1 to 5 and 7 to 9 is composed of, in order from the object side to the image side, a positive lens (first lens) L1, a negative lens (second lens) L2, a positive lens (third lens) L3, and a negative lens (fourth lens) L4. The first lens unit B1 in Embodiment 6 includes, in order from the object side to the image side, a positive lens (first lens) L1, a negative lens (second lens) L2, a positive lens, a positive lens (third lens) L3, and a negative lens (fourth lens) L4.

Next, the configuration of the second lens unit B2 will be described. The second lens unit B2 in all Embodiments includes a second-a lens unit B2a and a second-b lens unit B2b, which are disposed in order from the object side to the image side. The second-a lens unit B2a in Embodiments 1 to 3, Embodiments 5 to 6, and Embodiment 8 is composed of a negative lens (fifth lens) L5, a positive lens (sixth lens) L6, a negative lens, and a positive lens, which are arranged in this order from the object side to the image side. The second-a lens unit B2a in Embodiment 4 is composed of a negative lens (fifth lens) L5, a positive lens (sixth lens) L6, and a positive lens arranged in this order from the object side to the image side. The second-a lens unit B2a in Embodiment 7 is composed of, in order from the object side to the image side, a negative lens (fifth lens) L5, a positive lens (sixth lens) L6, a negative lens, and a positive lens. The second-a lens unit B2a in Embodiment 9 is composed of, in order from the object side to the image side, a negative lens (fifth lens) L5, a positive lens (sixth lens) L6, a negative lens, a positive lens, and a positive lens. The second-b lens unit B2b in Embodiments 1 to 6, 8, and 9 includes one positive lens (rear lens Lr), and the second-b lens unit B2b in Embodiment 7 includes a negative lens and a positive lens (rear lens Lr).

Hereinafter, Numerical Embodiments 1 to 9 corresponding to the respective Embodiments 1 to 9 will be described. In each Numerical Embodiment, the surface number i indicates the order of the surfaces from the object side. r is a radius of curvature (mm) of the i-th surface, and d is a lens thickness or an air gap (mm) on the optical axis between the i-th surface and the (i+1)-th surface. nd is the refractive index of the optical material between the i-th surface and the (i+1)-th surface with respect to the d-line, vd is the Abbe number of the optical material with respect to the d-line, and the effective diameter is the light beam effective diameter of the i-th surface.

The Abbe number with respect to the d-line vd is expressed by the expression (e),

$$vd = ( nd - 1 ) / ( nF - nC ) \qquad ( e )$$

where nd, nF, and nC represent refractive indices with respect to the d line (587.6 nm), F-ray (486.1 nm) and the C line (656.3 nm) of the Fraunhofer line, respectively.

BF represents a back focus (mm). The back focus is expressed by a distance on the optical axis from the rear surface (the lens surface closest to the image side) of the lens to the paraxial image plane in an air conversion length. The total lens length (mm) is a distance on the optical axis from the lens surface closest to the object side to the lens surface closest to the image side, and the total optical length (mm) is a length obtained by adding the back focus to the total lens length.

“*” attached to the right of the surface number means that the surface is a lens surface having an aspheric shape. The aspherical surface shape is expressed by the following formula,

$$x = ( {h}^{2} / R ) {/ [ 1 + \{ 1 - ( 1 + K ) {( h / R )}^{2} \} ]}^{1 / 2} + A 4 \times {h}^{4} + A 6 \times {h}^{6} + A 8 \times {h}^{8} + A 10 \times {h}^{10} + A 12 \times {h}^{12} \qquad ( f )$$

where x represents a displacement amount from a surface vertex in the optical axis direction, h represents a height from the optical axis in a direction orthogonal to the optical axis, a traveling direction of light is positive, R represents a paraxial radius of curvature, K is a conic constant, and A4, A6, A8, A10, and A12 represent aspherical surface coefficients. “e-M” in the conic constant and the aspheric coefficient means “×10^{-M}”.

Values corresponding to inequalities (1) to (18) in Numerical Embodiments 1 to 9 are summarized in Table 1. The optical system of each Numerical Embodiment satisfies all inequalities (1) to (18).

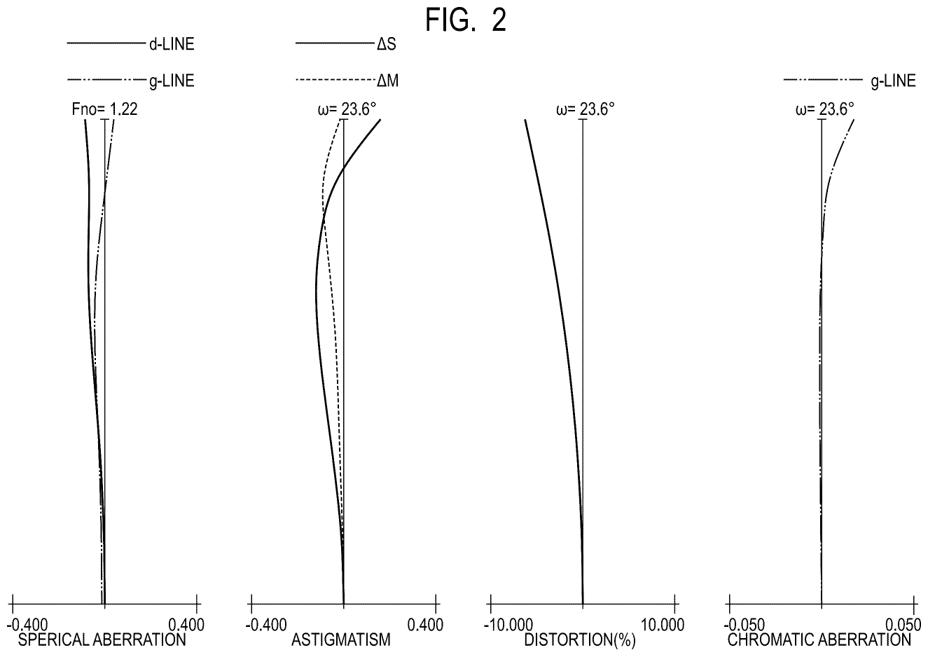

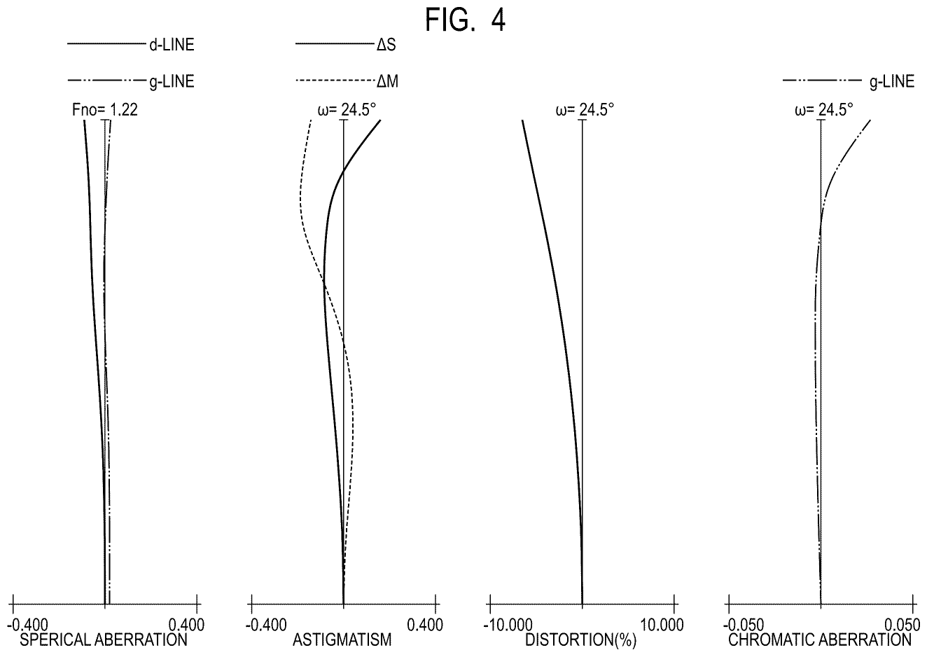

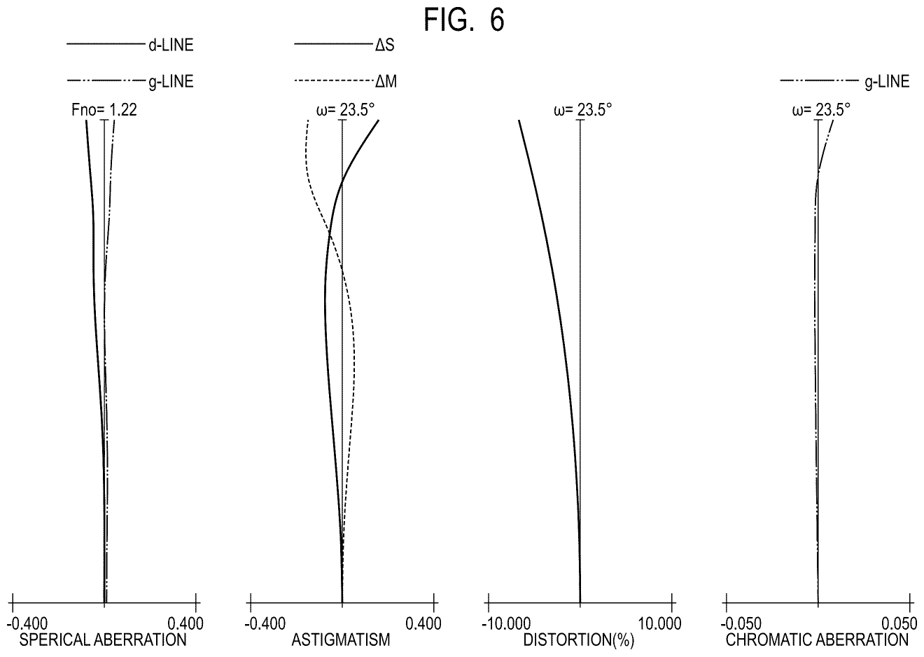

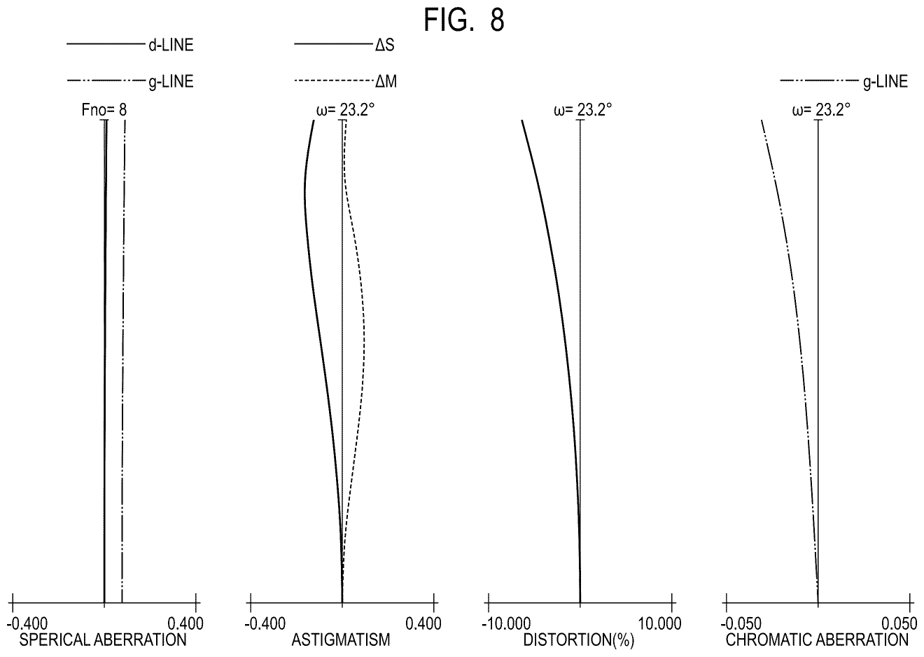

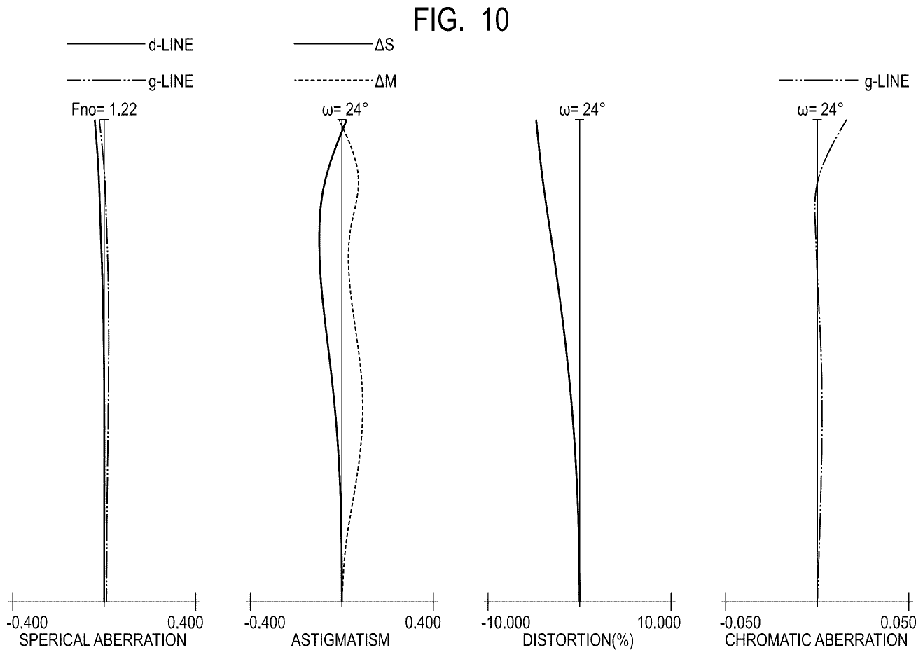

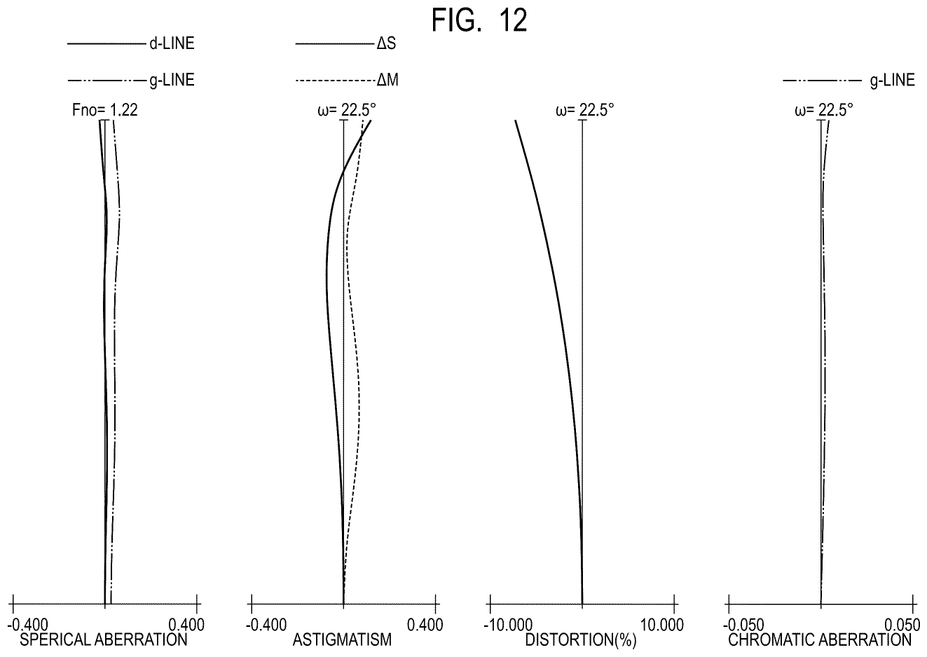

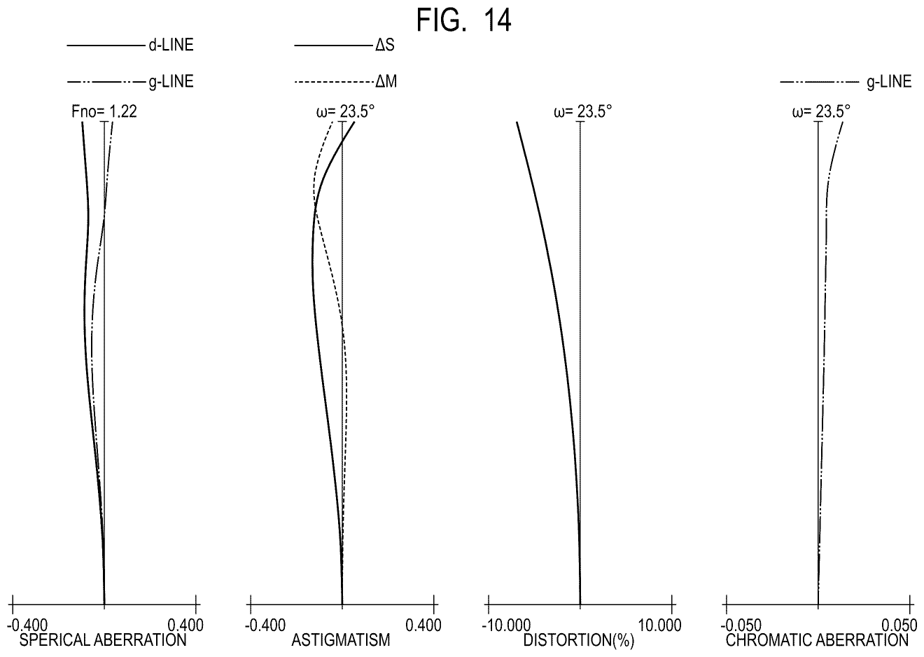

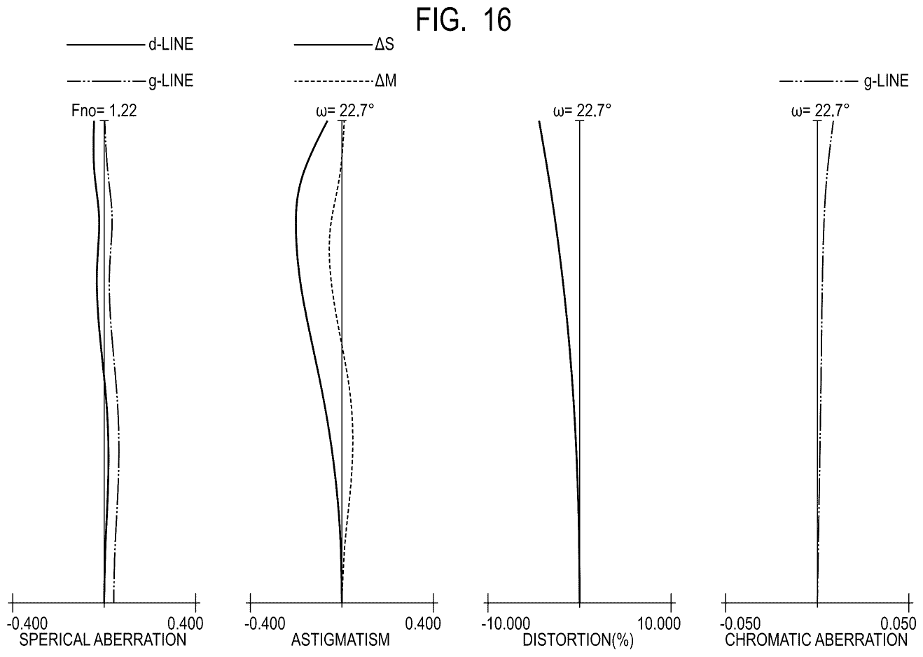

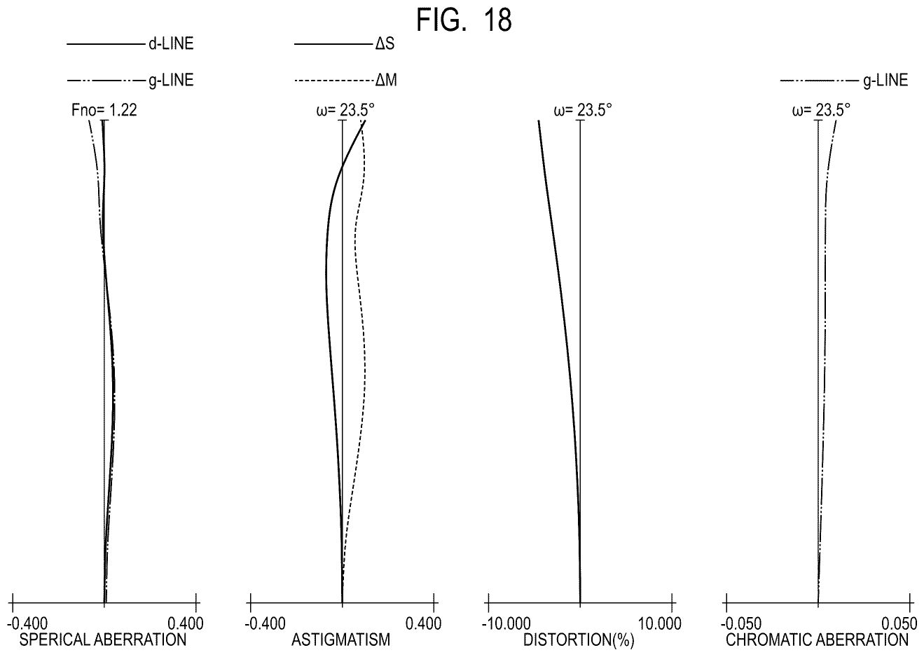

Further, FIGS. 2, 4, 6, 8, 10, 12, 14, 16, and 18 respectively show longitudinal aberrations (the spherical aberration, the astigmatism, the distortion, and the chromatic aberration) of the optical systems of Numerical Embodiments 1 to 9 in a state of being focused on infinity. In the spherical aberration diagram, Fno represents the F number, the solid line represents the spherical aberration with respect to the d line (wavelength: 587.6 nm), and the two-dot chain line represents the spherical aberration with respect to the g line (wavelength: 435.8 nm). In the astigmatism diagram, a solid line ΔS indicates a sagittal image plane, and a broken line ΔM indicates a meridional image plane. The distortion is for the d-line. The chromatic aberration diagram shows chromatic aberration of magnification at the g-line. ω is a half angle of view (degrees) obtained by paraxial calculation.

### Numerical Embodiment 1

Unit: mm
Surface Data

| Surface | | | | | Effective |
|---|---|---|---|---|---|
| number | R | d | nd | vd | diameter |
| 1 | 58.809 | 5.82 | 1.91082 | 35.3 | 37.87 |
| 2 | −199.152 | 1.45 | 1.68893 | 31.1 | 37.29 |
| 3 | 111.296 | 0.20 | | | 35.82 |
| 4 | 22.473 | 6.90 | 1.95375 | 32.3 | 33.18 |
| 5 | 37.446 | 0.35 | | | 30.00 |
| 6 | 40.746 | 1.25 | 1.84666 | 23.9 | 29.91 |
| 7 | 15.729 | 8.95 | | | 24.80 |
| 8(stop) | ∞ | 5.60 | | | 24.03 |
| 9 | −22.093 | 1.00 | 1.84666 | 23.9 | 23.42 |
| 10 | 30.212 | 8.36 | 1.95375 | 32.3 | 26.52 |
| 11 | −36.844 | 0.60 | | | 27.40 |
| 12* | −55.440 | 3.00 | 1.53504 | 55.7 | 27.25 |
| 13* | −64.575 | 0.60 | | | 28.85 |
| 14 | 185.451 | 5.35 | 1.83481 | 42.7 | 33.03 |
| 15 | −51.445 | 2.00 | | | 34.00 |
| 16 | 53.806 | 4.02 | 1.69680 | 55.5 | 37.73 |
| 17 | 119.308 | 23.16 | | | 37.61 |
| 18 | ∞ | 2.00 | 1.51633 | 64.1 | 50.00 |
| 19 | ∞ | 0.80 | | | 50.00 |
| Image | ∞ | | | | |
| plane | | | | | |

Aspherical Data
Surface 2
K = 0.00000e 00 A 4 = −4.13127e−06 A 6 = 3.26661e−08
A 8 = −3.30309e−10 A10 = 1.45131e−12 A12 = −2.20726e−15
Surface 13
K = 0.00000e 00 A 4 = −1.05724e−06 A 6 = 2.61774e−08
A 8 = −2.11056e−10 A10 = 8.70223e−13 A12 = −1.17242e−15
Various Data

| | |
|---|---|
| Focal length | 46.35 |
| F number | 1.22 |
| Half angle of | 23.62 |
| view (degrees) | |
| Image height | 20.27 |
| Total lens length | 55.45 |
| Total optical length | 80.73 |
| BF | 25.28 |

Single Lens Data

| | Leading | Focal |
|---|---|---|
| Lens | surface | length |
| 1 | 1 | 50.39 |
| 2 | 2 | −103.44 |
| 3 | 4 | 48.11 |
| 4 | 6 | −30.97 |
| 5 | 9 | −14.94 |
| 6 | 10 | 18.53 |
| 7 | 12 | −827.16 |
| 8 | 14 | 48.74 |
| 9 | 16 | 137.20 |

### Numerical Embodiment 2

Unit: mm
Surface Data

| Surface | | | | | Effective |
|---|---|---|---|---|---|
| number | r | D | nd | vd | diameter |
| 1 | 63.146 | 6.04 | 1.91082 | 35.3 | 38.74 |
| 2 | −144.139 | 1.45 | 1.68893 | 31.1 | 37.28 |
| 3 | 98.192 | 0.20 | | | 34.10 |
| 4 | 22.941 | 7.13 | 1.91082 | 35.3 | 32.21 |
| 5 | 36.161 | 0.44 | | | 28.61 |
| 6 | 40.224 | 1.25 | 1.71338 | 26.0 | 28.49 |
| 7 | 15.612 | 8.59 | | | 24.12 |
| 8(stop) | ∞ | 5.93 | | | 23.43 |
| 9 | −20.715 | 1.00 | 1.75575 | 24.7 | 22.84 |
| 10 | 29.090 | 8.10 | 1.91082 | 35.3 | 26.00 |
| 11 | −38.091 | 0.60 | | | 26.76 |
| 12* | −59.962 | 3.00 | 1.53504 | 55.7 | 26.59 |
| 13* | −64.440 | 0.60 | | | 29.11 |
| 14 | 278.856 | 5.49 | 1.83481 | 42.7 | 32.90 |
| 15 | −47.240 | 2.00 | | | 34.00 |
| 16 | 53.158 | 4.38 | 1.69680 | 55.5 | 37.94 |
| 17 | 122.609 | 22.14 | | | 37.79 |
| 18 | ∞ | 2.00 | 1.51633 | 64.1 | 50.00 |
| 19 | ∞ | 0.80 | | | 50.00 |
| Image plane | ∞ | | | | |

Aspherical Data
Twelfth Surface
K = 0.00000e 00 A 4 = −4.08513e−06 A 6 = 9.87225e−09
A 8 = −2.91010e−10 A10 = 1.81417e−12 A12 = −3.34519e−15
Surface 13
K = 0.00000e 00 A 4 = 1.68915e−06 A 6 = −1.66585e−09
A 8 = −1.15871e−10 A10 = 9.95219e−13 A12 = −1.82759e−15
Various Data

| | |
|---|---|
| Focal length | 44.29 |
| F number | 1.22 |
| Half angle of | 24.54 |
| view (degrees) | |
| Image height | 20.22 |
| Total lens length | 56.19 |
| Total optical length | 80.46 |
| BF | 24.26 |

Single Lens Data

| | Leading | Focal |
|---|---|---|
| Lens | surface | length |
| 1 | 1 | 48.89 |
| 2 | 2 | −84.57 |
| 3 | 4 | 54.81 |
| 4 | 6 | −36.54 |
| 5 | 9 | −15.87 |
| 6 | 10 | 19.21 |
| 7 | 12 | −2104.06 |
| 8 | 14 | 48.76 |
| 9 | 16 | 131.28 |

### Numerical Embodiment 3

Unit: mm
Surface Data

| Surface | | | | | Effective |
|---|---|---|---|---|---|
| number | R | D | nd | vd | diameter |
| 1 | 57.628 | 5.62 | 1.91082 | 35.3 | 37.87 |
| 2 | −239.077 | 1.45 | 1.68893 | 31.1 | 37.32 |
| 3 | 107.380 | 0.20 | | | 35.86 |
| 4 | 22.691 | 6.98 | 1.95375 | 32.3 | 33.29 |
| 5 | 32.201 | 0.40 | | | 29.49 |
| 6 | 34.885 | 1.25 | 1.79631 | 22.6 | 29.39 |
| 7 | 15.706 | 8.98 | | | 24.81 |
| 8(stop) | ∞ | 5.57 | | | 24.00 |
| 9 | −22.443 | 1.00 | 1.84666 | 23.9 | 23.37 |
| 10 | 29.910 | 8.50 | 1.95375 | 32.3 | 26.29 |
| 11 | −37.452 | 0.60 | | | 27.21 |
| 12* | −53.948 | 3.00 | 1.53504 | 55.7 | 27.05 |
| 13* | −64.454 | 0.60 | | | 28.62 |
| 14 | 168.233 | 5.25 | 1.83481 | 42.7 | 32.88 |
| 15 | −52.953 | 2.00 | | | 33.81 |
| 16 | 53.536 | 4.03 | 1.69680 | 55.5 | 37.51 |
| 17 | 119.921 | 22.93 | | | 37.39 |
| 18 | ∞ | 2.00 | 1.51633 | 64.1 | 50.00 |
| 19 | ∞ | 0.80 | | | 50.00 |
| Image | ∞ | | | | |
| plane | | | | | |

Aspherical Data
Twelfth Surface
K = 0.00000e 00 A 4 = −4.53352e−06 A 6 = 5.92268e−08
A 8 = −6.00072e−10 A10 = 2.55427e−12 A12 = −3.91981e−15
Surface 13
K = 0.00000e 00 A 4 = −7.43691e−07 A 6 = 3.86827e−08
A 8 = −3.52492e−10 A10 = 1.37587e−12 A12 = −1.80871e−15
Various Data

| | |
|---|---|
| Focal length | 46.35 |
| F number | 1.22 |
| Half angle of | 23.54 |
| view (degrees) | |
| Image height | 20.19 |
| Total lens length | 55.43 |
| Total optical length | 80.48 |
| BF | 25.05 |

Single Lens Data

| | Leading | Focal |
|---|---|---|
| Lens | surface | length |
| 1 | 1 | 51.45 |
| 2 | 2 | −107.37 |
| 3 | 4 | 59.32 |
| 4 | 6 | −36.94 |
| 5 | 9 | −15.01 |
| 6 | 10 | 18.58 |
| 7 | 12 | −686.97 |
| 8 | 14 | 48.77 |
| 9 | 16 | 135.41 |

### Numerical Embodiment 4

Unit: mm
Surface Data

| Surface | | | | | Effective |
|---|---|---|---|---|---|
| number | R | d | nd | vd | diameter |
| 1 | 56.901 | 5.60 | 1.91082 | 35.3 | 38.71 |
| 2 | −330.330 | 1.45 | 1.69895 | 30.1 | 38.15 |
| 3 | 102.117 | 0.20 | | | 36.69 |
| 4 | 22.155 | 6.90 | 1.95375 | 32.3 | 33.96 |
| 5 | 39.483 | 0.23 | | | 31.24 |
| 6 | 41.742 | 1.25 | 1.84666 | 23.9 | 31.19 |
| 7 | 15.600 | 9.62 | | | 25.38 |
| 8(stop) | ∞ | 5.59 | | | 24.47 |
| 9 | −22.712 | 1.00 | 1.84666 | 23.9 | 23.82 |
| 10 | 34.944 | 7.30 | 1.95375 | 32.3 | 26.62 |
| 11 | −42.615 | 2.35 | | | 27.40 |
| 12* | 241.579 | 6.50 | 1.85400 | 40.4 | 28.86 |
| 13* | −45.367 | 2.00 | | | 31.11 |
| 14 | 53.028 | 3.13 | 1.67790 | 55.3 | 35.40 |
| 15 | 127.097 | 23.51 | | | 35.42 |
| 16 | ∞ | 2.00 | 1.51633 | 64.1 | 50.00 |
| 17 | ∞ | 0.80 | | | 50.00 |
| Image | ∞ | | | | |
| plane | | | | | |

Aspherical Data
Twelfth Surface
K = 0.00000e 00 A 4 = −2.00913e−06 A 6 = 7.10693e−09
A 8 = −4.73193e−11 A10 = 5.42810e−15
Surface 13
K = 0.00000e 00 A 4 = 8.96474e−07 A 6 = −6.93112e−09
A 8 = 2.68096e−11 A10 = −1.15923e−13
Various Data

| | |
|---|---|
| Focal length | 47.38 |
| F number | 1.22 |
| Half angle of | 23.22 |
| view (degrees) | |
| Image height | 20.33 |
| Total lens length | 53.13 |
| Total optical length | 78.76 |
| BF | 25.63 |

Single Lens Data

| | Leading | Focal |
|---|---|---|
| Lens | surface | length |
| 1 | 1 | 53.66 |
| 2 | 2 | −111.45 |
| 3 | 4 | 44.31 |
| 4 | 6 | −30.08 |
| 5 | 9 | −16.13 |
| 6 | 10 | 21.10 |
| 7 | 12 | 45.20 |
| 8 | 14 | 131.97 |

### Numerical Embodiment 5

Unit: mm
Surface Data

| Surface | | | | | Effective |
|---|---|---|---|---|---|
| number | R | d | nd | vd | diameter |
| 1 | 58.148 | 6.61 | 1.91082 | 35.3 | 37.87 |
| 2 | −110.059 | 1.45 | 1.71736 | 29.5 | 37.27 |
| 3 | 82.486 | 0.20 | | | 35.27 |
| 4 | 22.853 | 7.40 | 1.85150 | 40.8 | 33.20 |
| 5 | 28.437 | 1.25 | 1.62200 | 30.7 | 28.76 |
| 6 | 15.412 | 9.30 | | | 24.89 |
| 7(stop) | ∞ | 5.59 | | | 23.99 |
| 8 | −22.365 | 1.00 | 1.69895 | 30.1 | 23.30 |
| 9 | 30.359 | 10.37 | 1.78800 | 47.4 | 25.59 |
| 10 | −28.352 | 0.69 | | | 26.67 |
| 11 | −25.595 | 2.00 | 1.84666 | 23.8 | 26.77 |
| 12 | −47.819 | 0.60 | | | 30.45 |
| 13* | 172.444 | 7.34 | 1.89190 | 37.1 | 36.48 |
| 14* | −40.805 | 2.00 | | | 37.82 |
| 15 | 60.400 | 4.05 | 1.69680 | 55.5 | 40.95 |
| 16 | 127.598 | 23.46 | | | 40.70 |
| 17 | ∞ | 2.00 | 1.51633 | 64.1 | 50.00 |
| 18 | ∞ | 0.80 | | | 50.00 |
| Image | ∞ | | | | |
| plane | | | | | |

Aspherical Data
Surface 13
K = 0.00000e 00 A 4 = −1.63300e−06 A 6 = −1.61694e−09
A 8 = 4.20250e−12 A10 = −1.58345e−14
Fourteenth Surface
K = 0.00000e 00 A 4 = 1.67366e−06 A 6 = −6.33745e−09
A 8 = 2.24169e−11 A10 = −3.92604e−14
Various Data

| | |
|---|---|
| Focal length | 46.35 |
| F number | 1.22 |
| Half angle of | 23.97 |
| view (degrees) | |
| Image height | 20.61 |
| Total lens length | 59.85 |
| Total optical length | 85.43 |
| BF | 25.58 |

Single Lens Data

| | Leading | Focal |
|---|---|---|
| Lens | surface | length |
| 1 | 1 | 42.57 |
| 2 | 2 | −65.52 |
| 3 | 4 | 84.92 |
| 4 | 5 | −56.17 |
| 5 | 8 | −18.28 |
| 6 | 9 | 20.18 |
| 7 | 11 | −67.85 |
| 8 | 13 | 37.61 |
| 9 | 15 | 160.62 |

### Numerical Embodiment 6

Unit: mm
Surface Data

| Surface | | | | | Effective |
|---|---|---|---|---|---|
| number | R | d | nd | vd | diameter |
| 1 | 37.853 | 5.58 | 1.95375 | 32.3 | 39.62 |
| 2 | 108.395 | 1.45 | 1.76182 | 26.5 | 38.64 |
| 3 | 36.973 | 2.31 | | | 36.01 |
| 4 | 64.290 | 2.65 | 1.95375 | 32.3 | 35.96 |
| 5 | 141.129 | 0.25 | | | 35.48 |
| 6 | 21.998 | 4.97 | 1.95375 | 32.3 | 32.12 |
| 7 | 34.938 | 0.61 | | | 30.32 |
| 8 | 40.558 | 1.25 | 1.84666 | 23.9 | 30.22 |
| 9 | 15.887 | 9.03 | | | 25.08 |
| 10(stop) | ∞ | 5.92 | | | 24.28 |
| 11 | −22.320 | 1.00 | 1.84666 | 23.9 | 23.58 |
| 12 | 32.253 | 7.87 | 1.95375 | 32.3 | 26.56 |
| 13 | −39.332 | 0.86 | | | 27.40 |
| 14* | −51.734 | 3.00 | 1.53504 | 55.7 | 27.33 |
| 15* | −53.909 | 1.14 | | | 27.95 |
| 16 | 145.068 | 5.78 | 1.83481 | 42.7 | 33.64 |
| 17 | −50.367 | 2.00 | | | 34.57 |
| 18 | 51.662 | 2.93 | 1.69680 | 55.5 | 37.83 |
| 19 | 92.767 | 23.90 | | | 37.69 |
| 20 | ∞ | 2.00 | 1.51633 | 64.1 | 50.00 |
| 21 | ∞ | 0.80 | | | 50.00 |
| Image | ∞ | | | | |
| plane | | | | | |

Aspherical Data
Fourteenth Surface
K = 0.00000e 00 A 4 = −2.83051e−06 A 6 = 8.02748e−09
A 8 = −2.06031e−10 A10 = 1.26748e−12 A12 = −2.35419e−15
Fifteenth Surface
K = 0.00000e 00 A 4 = 1.61914e−06 A 6 = −1.45666e−08
A 8 = 6.68526e−11 A10 = −6.09716e−14 A12 = 4.71218e−17
Various Data

| | |
|---|---|
| Focal length | 48.50 |
| F number | 1.22 |
| Half angle of | 22.47 |
| view (degrees) | |
| Image height | 20.06 |
| Total lens length | 58.61 |
| Total optical length | 84.63 |
| BF | 26.02 |

Single Lens Data

| | Leading | Focal |
|---|---|---|
| Lens | surface | length |
| 1 | 1 | 58.72 |
| 2 | 2 | −74.31 |
| 3 | 4 | 121.75 |
| 4 | 6 | 52.44 |
| 5 | 8 | −31.58 |
| 6 | 11 | −15.45 |
| 7 | 12 | 19.63 |
| 8 | 14 | −4616.58 |
| 9 | 16 | 45.40 |
| 10 | 18 | 162.57 |

### Numerical Embodiment 7

Unit: mm
Surface Data

| Surface | | | | | Effective |
|---|---|---|---|---|---|
| number | r | d | nd | vd | diameter |
| 1 | 59.415 | 5.61 | 1.91082 | 35.3 | 37.87 |
| 2 | −235.281 | 1.45 | 1.68893 | 31.1 | 37.31 |
| 3 | 129.550 | 0.20 | | | 35.99 |
| 4 | 22.960 | 7.07 | 1.95375 | 32.3 | 33.25 |
| 5 | 34.041 | 0.35 | | | 29.45 |
| 6 | 36.705 | 1.25 | 1.84666 | 23.9 | 29.36 |
| 7 | 16.000 | 8.73 | | | 24.80 |
| 8(stop) | ∞ | 5.65 | | | 24.00 |
| 9 | −22.636 | 1.00 | 1.84666 | 23.9 | 23.32 |
| 10 | 29.783 | 9.39 | 1.95375 | 32.3 | 26.17 |
| 11 | −36.629 | 0.60 | | | 27.31 |
| 12* | −53.913 | 3.00 | 1.53504 | 55.7 | 27.08 |
| 13* | −55.548 | 0.60 | | | 29.11 |
| 14 | 255.198 | 4.84 | 1.83481 | 42.7 | 33.09 |
| 15 | −55.184 | 2.00 | | | 34.00 |
| 16 | −314.211 | 1.50 | 1.96300 | 24.1 | 36.02 |
| 17 | 150.629 | 0.50 | | | 36.96 |
| 18 | 53.202 | 5.78 | 1.91082 | 35.3 | 39.97 |
| 19 | −2603.192 | 21.91 | | | 39.99 |
| 20 | ∞ | 2.00 | 1.51633 | 64.1 | 50.00 |
| 21 | ∞ | 0.80 | | | 50.00 |
| Image | ∞ | | | | |
| plane | | | | | |

Aspherical Data
Twelfth Surface
K = 0.00000e 00 A 4 = 7.84525e−07 A 6 = 1.49776e−10
A 8 = −2.82568e−10 A10 = 1.72724e−12 A12 = −3.04733e−15
Surface 13
K = 0.00000e 00 A 4 = 2.89958e−06 A 6 = 4.68979e−09
A 8 = −1.95912e−10 A10 = 1.04036e−12 A12 = −1.52350e−15
Various Data

| | |
|---|---|
| Focal length | 46.35 |
| F number | 1.22 |
| Half angle of | 23.48 |
| view (degrees) | |
| Image height | 20.14 |
| Total lens length | 59.53 |
| Total optical length | 83.56 |
| BF | 24.03 |

Single Lens Data

| | Leading | Focal |
|---|---|---|
| Lens | surface | length |
| 1 | 1 | 52.56 |
| 2 | 2 | −121.07 |
| 3 | 4 | 56.38 |
| 4 | 6 | −34.46 |
| 5 | 9 | −15.06 |
| 6 | 10 | 18.50 |
| 7 | 12 | −9494.40 |
| 8 | 14 | 54.74 |
| 9 | 16 | −105.56 |
| 10 | 18 | 57.30 |

### Numerical Embodiment 8

Unit: mm
Surface Data

| Surface | | | | | Effective |
|---|---|---|---|---|---|
| number | R | d | nd | vd | diameter |
| 1 | 47.732 | 7.00 | 1.91082 | 35.3 | 40.44 |
| 2 | −1801.946 | 1.55 | 1.67270 | 32.1 | 39.40 |
| 3 | 93.743 | 0.20 | | | 37.61 |
| 4 | 23.371 | 6.97 | 2.00100 | 29.1 | 34.31 |
| 5 | 44.286 | 0.18 | | | 31.37 |
| 6 | 46.338 | 1.25 | 1.92286 | 20.9 | 31.31 |
| 7 | 15.992 | 9.26 | | | 25.34 |
| 8(stop) | ∞ | 5.21 | | | 24.21 |
| 9 | −25.289 | 1.00 | 1.92286 | 20.9 | 23.33 |
| 10 | 33.884 | 6.92 | 2.00069 | 25.5 | 25.27 |
| 11 | −41.471 | 1.51 | | | 25.90 |
| 12* | −58.916 | 3.00 | 1.53504 | 55.7 | 25.63 |
| 13* | −68.394 | 0.85 | | | 27.36 |
| 14 | 112.733 | 7.00 | 1.83481 | 42.7 | 32.75 |
| 15 | −52.131 | 2.00 | | | 34.31 |
| 16 | 64.710 | 3.67 | 1.65160 | 58.5 | 37.44 |
| 17 | 133.784 | 20.74 | | | 37.43 |
| 18 | ∞ | 2.00 | 1.51633 | 64.1 | 50.00 |
| 19 | ∞ | 0.80 | | | 50.00 |
| Image | ∞ | | | | |
| plane | | | | | |

Aspherical Data
Twelfth Surface
K = 0.00000e 00 A 4 = −7.27810e−06 A 6 = 1.02478e−07
A 8 = −1.13696e−09 A10 = 5.89581e−12 A12 = −1.12642e−14
Surface 13
K = 0.00000e 00 A 4 = −1.05724e−06 A 6 = 2.61774e−08
A 8 = −2.11056e−10 A10 = 8.70223e−13 A12 = −1.17242e−15
Various Data

| | |
|---|---|
| Focal length | 49.50 |
| F number | 1.22 |
| Half angle of view | 22.67 |
| (degrees) | |
| Image height | 20.68 |
| Total lens length | 57.57 |
| Total optical length | 80.43 |
| BF | 22.86 |

Single Lens Data

| | Leading | Focal |
|---|---|---|
| Lens | surface | length |
| 1 | 1 | 51.15 |
| 2 | 2 | −132.42 |
| 3 | 4 | 42.37 |
| 4 | 6 | −26.99 |
| 5 | 9 | −15.57 |
| 6 | 10 | 19.53 |
| 7 | 12 | −893.11 |
| 8 | 14 | 43.54 |
| 9 | 16 | 188.39 |

### Numerical Embodiment 9

Unit: mm
Surface Data

| Surface | | | | | Effective |
|---|---|---|---|---|---|
| number | R | D | nd | vd | diameter |
| 1 | 53.036 | 7.17 | 1.95375 | 32.3 | 38.71 |
| 2 | −114.083 | 1.45 | 1.72825 | 28.5 | 37.99 |
| 3 | 67.150 | 0.20 | | | 35.40 |
| 4 | 25.418 | 6.50 | 1.95375 | 32.3 | 33.62 |
| 5 | 48.048 | 0.50 | | | 30.88 |
| 6 | 56.446 | 1.25 | 1.78470 | 26.3 | 30.76 |
| 7 | 17.349 | 8.55 | | | 25.90 |
| 8(stop) | ∞ | 5.59 | | | 25.28 |
| 9 | −26.285 | 1.00 | 1.68893 | 31.1 | 24.72 |
| 10 | 25.406 | 10.60 | 1.85150 | 40.8 | 27.11 |
| 11 | −28.163 | 0.83 | | | 27.57 |
| 12 | −24.955 | 2.00 | 1.72825 | 28.5 | 27.26 |
| 13 | −81.883 | 0.76 | | | 28.05 |
| 14* | −6479.785 | 3.00 | 1.53504 | 55.7 | 28.07 |
| 15* | −554.987 | 0.71 | | | 31.30 |
| 16 | 239.455 | 7.70 | 1.77250 | 49.6 | 35.26 |
| 17 | −36.092 | 2.00 | | | 36.63 |
| 18 | 95.816 | 3.61 | 1.77250 | 49.6 | 39.41 |
| 19 | 304.263 | 24.59 | | | 39.38 |
| 20 | ∞ | 2.00 | 1.51633 | 64.1 | 50.00 |
| 21 | ∞ | 0.80 | | | 50.00 |
| Image | ∞ | | | | |
| plane | | | | | |

Aspherical Data
Fourteenth Surface
K = 0.00000e 00 A 4 = −2.85186e−05 A 6 = 4.80836e−09
A 8 = −1.14332e−10 A10 = 4.01236e−13
Fifteenth Surface
K = 0.00000e 00 A 4 = −1.58615e−05 A 6 = −8.00676e−09
A 8 = 3.11911e−11 A10 = 8.90237e−14
Various Data

| | |
|---|---|
| Focal length | 47.38 |
| F number | 1.22 |
| Half angle of | 23.55 |
| view (degrees) | |
| Image height | 20.65 |
| Total lens length | 63.43 |
| Total optical length | 90.13 |
| BF | 26.71 |

Single Lens Data

| | Leading | Focal |
|---|---|---|
| Lens | surface | length |
| 1 | 1 | 38.77 |
| 2 | 2 | −57.85 |
| 3 | 4 | 49.62 |
| 4 | 6 | −32.38 |
| 5 | 9 | −18.61 |
| 6 | 10 | 17.26 |
| 7 | 12 | −50.03 |
| 8 | 14 | 1134.25 |
| 9 | 16 | 41.10 |
| 10 | 18 | 179.69 |

TABLE 1
Values corresponding to inequalities (1)-(18) of Numerical Embodiments 1-9

| | | Numerical Embodiment | | | | | | | | |
|---|---|---|---|---|---|---|---|---|---|---|
| Inequality | | 1 | 2 | 3 | 4 | 5 | 6 | 7 | 8 | 9 |
| (1) | f × PL2 | −0.265 | −0.310 | −0.256 | −0.250 | −0.412 | −0.370 | −0.227 | −0.223 | −0.474 |
| (2) | vdL45 | 23.870 | 25.375 | 23.240 | 23.870 | 30.395 | 23.870 | 23.870 | 20.881 | 28.680 |
| (3) | fSP/F | −0.177 | −0.212 | −0.186 | −0.173 | −0.239 | −0.170 | −0.182 | −0.162 | −0.239 |
| (4) | TSP/TD | 0.263 | 0.258 | 0.262 | 0.286 | 0.249 | 0.255 | 0.242 | 0.251 | 0.223 |
| (5) | (TB1 + TB2)/f | 0.882 | 0.941 | 0.882 | 0.800 | 0.970 | 0.900 | 0.974 | 0.871 | 1.040 |
| (6) | Sk/f | 0.545 | 0.548 | 0.541 | 0.541 | 0.552 | 0.537 | 0.518 | 0.462 | 0.564 |
| (7) | NdLp | 1.870 | 1.853 | 1.870 | 1.870 | 1.828 | 1.930 | 1.913 | 1.880 | 1.813 |
| (8) | PL245 | −2.756 | −2.607 | −2.626 | −2.694 | −2.413 | −2.902 | −2.622 | −2.831 | −2.802 |
| (9) | fB1B2a/fB2b | 0.430 | 0.432 | 0.437 | 0.459 | 0.355 | 0.365 | 0.477 | 0.307 | 0.316 |
| (10) | SFL2 | −0.283 | −0.190 | −0.380 | −0.528 | −0.143 | −2.035 | −0.290 | −0.901 | −0.259 |
| (11) | SFLr | 2.643 | 2.531 | 2.613 | 2.432 | 2.798 | 3.514 | 0.960 | 2.874 | 1.919 |
| (12) | TL/f | 1.742 | 1.817 | 1.736 | 1.662 | 1.843 | 1.745 | 1.803 | 1.625 | 1.902 |
| (13) | fB1/fB2 | 3.427 | 3.888 | 3.351 | 3.181 | 3.356 | 3.563 | 3.394 | 2.714 | 4.286 |
| (14) | fL1L2/fB1 | 0.761 | 0.817 | 0.782 | 0.827 | 0.922 | 1.619 | 0.747 | 0.761 | 0.670 |
| (15) | fL5/fL6 | −0.806 | −0.826 | −0.808 | −0.764 | −0.906 | −0.787 | −0.814 | −0.797 | −1.078 |
| (16) | ω | 23.615 | 24.536 | 23.531 | 23.225 | 23.965 | 22.477 | 23.483 | 22.676 | 23.549 |
| (17) | Fno | 1.224 | 1.224 | 1.224 | 1.224 | 1.224 | 1.224 | 1.224 | 1.224 | 1.224 |
| (18) | Di | −6.276 | −6.533 | −6.711 | −6.078 | −4.751 | −7.311 | −6.939 | −4.427 | −4.546 |
| | f | 46.350 | 44.290 | 46.350 | 47.380 | 46.350 | 48.500 | 46.350 | 49.500 | 47.380 |
| | fL1 | 50.389 | 48.888 | 51.446 | 53.662 | 42.569 | 58.717 | 52.558 | 51.145 | 38.773 |
| | fL2 | −103.436 | −84.569 | −107.373 | −111.447 | −65.520 | −74.309 | −121.075 | −132.419 | −57.848 |
| | fL3 | 48.107 | 54.811 | 59.315 | 44.313 | 84.924 | 52.437 | 56.383 | 42.373 | 49.622 |
| | fL4 | −30.969 | −36.539 | −36.944 | −30.080 | −56.168 | −31.582 | −34.455 | −26.995 | −32.376 |
| | fL5 | −14.941 | −15.872 | −15.013 | −16.130 | −18.282 | −15.450 | −15.059 | −15.566 | −18.605 |
| | fL6 | 18.533 | 19.212 | 18.580 | 21.101 | 20.175 | 19.634 | 18.500 | 19.532 | 17.257 |
| | fL1L2 | 93.117 | 107.611 | 93.769 | 98.118 | 108.368 | 206.981 | 89.078 | 79.000 | 101.206 |
| | fB1 | 122.305 | 131.709 | 119.953 | 118.678 | 117.497 | 127.880 | 119.263 | 103.799 | 151.033 |
| | fB2 | 35.684 | 33.874 | 35.794 | 37.307 | 35.009 | 35.895 | 35.139 | 38.243 | 35.238 |
| | fB1B2a | 59.038 | 56.681 | 59.116 | 60.592 | 56.997 | 59.390 | 58.772 | 57.807 | 56.744 |
| | fB2b | 137.198 | 131.285 | 135.413 | 131.974 | 160.616 | 162.569 | 123.272 | 188.392 | 179.693 |
| | fSP | −8.185 | −9.400 | −8.603 | −8.175 | −11.064 | −8.234 | −8.418 | −8.021 | −11.337 |
| | NdL2 | 1.689 | 1.689 | 1.689 | 1.699 | 1.717 | 1.762 | 1.689 | 1.673 | 1.728 |
| | NdL4 | 1.847 | 1.713 | 1.796 | 1.847 | 1.622 | 1.847 | 1.847 | 1.923 | 1.785 |
| | NdL5 | 1.847 | 1.756 | 1.847 | 1.847 | 1.699 | 1.847 | 1.847 | 1.923 | 1.689 |
| | R1L2 | −199.152 | −144.139 | −239.077 | −330.330 | −110.059 | 108.395 | −235.281 | −1801.946 | −114.083 |
| | R2L2 | 111.296 | 98.192 | 107.380 | 102.117 | 82.486 | 36.973 | 129.550 | 93.743 | 67.150 |
| | R2L4 | 15.729 | 15.612 | 15.706 | 15.600 | 15.412 | 15.887 | 16.000 | 15.992 | 17.349 |
| | R1L5 | −22.093 | −20.715 | −22.443 | −22.712 | −22.365 | −22.320 | −22.636 | −25.289 | −26.285 |
| | R1Lr | 53.806 | 53.158 | 53.536 | 53.028 | 60.400 | 51.662 | 53.202 | 64.710 | 95.816 |
| | R2Lr | 119.308 | 122.609 | 119.921 | 127.097 | 127.598 | 92.767 | −2603.192 | 133.784 | 304.263 |
| | TSP | 14.557 | 14.517 | 14.544 | 15.213 | 14.887 | 14.951 | 14.382 | 14.474 | 14.144 |
| | TD | 55.446 | 56.194 | 55.429 | 53.129 | 59.852 | 58.605 | 59.532 | 57.574 | 63.425 |
| | TB1 | 15.964 | 16.509 | 15.894 | 15.636 | 16.906 | 19.080 | 15.943 | 17.148 | 17.078 |
| | TB2 | 24.926 | 25.168 | 24.991 | 22.280 | 28.060 | 24.575 | 29.207 | 25.953 | 32.202 |
| | TL | 80.726 | 80.456 | 80.483 | 78.757 | 85.429 | 84.628 | 83.563 | 80.430 | 90.130 |
| | Sk | 25.280 | 24.262 | 25.054 | 25.629 | 25.577 | 26.023 | 24.031 | 22.856 | 26.706 |

### [Image Pickup Apparatus]

Next, Embodiment of a digital still camera (image pickup apparatus) 10 using the optical system of the disclosure as an image pickup optical system will be described with reference to FIG. 19. In FIG. 19, reference numeral 13 denotes a camera body, and 11 denotes an image pickup optical system configured by any of the optical systems described in Embodiments 1-9. Reference numeral 12 denotes a solid-state image pickup element (photoelectric conversion element) such as a CCD sensor or a CMOS sensor which is built in the camera body 13 and receives and photoelectrically converts an optical image formed by the image pickup optical system 11. The camera body 13 may be a so-called single-lens reflex camera having a quick return mirror or a so-called mirrorless camera not having a quick return mirror.

The image pickup apparatus 10 preferably has a function of correcting distortion occurring in the image pickup optical system 11 by software. With this function, it is possible to achieve both downsizing of the optical system and correction of the distortion remaining in the captured image.

As described above, by applying the optical system of the disclosure to an image pickup apparatus such as a digital still camera, it is possible to obtain an image pickup apparatus having a small lens.

### [Lens Apparatus]

FIG. 20 is a schematic diagram of a lens apparatus 20 of the disclosure The lens apparatus 20 is a so-called interchangeable lens detachably attached to a camera body (not shown).

The lens apparatus 20 includes an image pickup optical system 21 similar to any of the optical systems of Embodiments 1 to 9. The lens apparatus 20 also includes a focus operation unit 22 and an operation unit 23 for changing the image pickup mode.

When a user operates the focus operation unit 22, the arrangement of the lens units of the image pickup optical system 21 is changed mechanically or electrically, and the focal position is changed.

Further, the user may operate the operation unit 23 to change the arrangement of the lens units of the image pickup optical system 21 for purposes other than focusing. For example, the aberration of the image pickup optical system 21 may be changed by mechanically or electrically changing the arrangement of the lens units of the image pickup optical system 21 in accordance with the operation of the operation unit 23. At this time, it is preferable that the focus position does not substantially change.

According to the disclosure, it is possible to provide an optical system in which the entire lens system is small in size while having a large aperture ratio, various aberrations including the chromatic aberration are satisfactorily corrected, and a high optical performance is obtained.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-002958, filed Jan. 8, 2025, which is hereby incorporated by reference herein in its entirety.

What is claimed is:

1. An optical system comprising, in order from an object side to an image side, a first lens unit having a positive refractive power, an aperture stop, and a second lens unit having a positive refractive power,
wherein the first lens unit comprises, in order from the object side to the image side, a first subunit and a second subunit,
wherein the first subunit comprises, in order from the object side to the image side, a first lens having a positive refractive power and a second lens having a negative refractive power,
wherein the second subunit comprises, in order from the object side to the image side, a third lens having a positive refractive power and a fourth lens having a negative refractive power,
wherein the second lens unit comprises, in order from the object side to the image side, a fifth lens having a negative refractive power, a sixth lens having a positive refractive power, and two or more lenses,
wherein a total number of lenses disposed in the optical system is 10 or less,
wherein a total number of lens units disposed in the optical system is two,
wherein a total number of subunits disposed in the first lens unit is two,
wherein a total number of lenses disposed in the second subunit is two,
wherein in an infinity focus state, an air gap on an optical axis between the first lens unit and the second lens unit is larger than a sum of air gaps between lenses included in the second lens unit, and
wherein the following inequalities are satisfied,
$$- 1. \leq f \times PL 2 \leq - 0 \text{.15}$$
$$15. 00 \leq vdL 45 \leq 32.00$$
where f represents a focal length of an entire system of the optical system, PL2 represents a Petzval sum of the second lens, and vdL45 represents an average value of Abbe numbers of the fourth lens and the fifth lens.

2. An optical system comprising, in order from an object side to an image side,
a first lens unit having a positive refractive power, an aperture stop, and a second lens unit having a positive refractive power,
wherein the first lens unit comprises, in order from the object side to the image side, a first subunit and a second subunit,
wherein the first subunit comprises, in order from the object side to the image side, a first lens having a positive refractive power and a second lens having a negative refractive power,
wherein the second subunit comprises, in order from the object side to the image side, a third lens having a positive refractive power and a fourth lens having a negative refractive power,
wherein the second lens unit includes, in order from the object side to the image side, a fifth lens having a negative refractive power, a sixth lens having a positive refractive power, and two or more lenses,
wherein a total number of lenses disposed in the optical system is 10 or less,
wherein a total number of lens units disposed in the optical system is two,
wherein a total number of subunits disposed in the first lens unit is two,
wherein a total number of lenses disposed in the second subunit is two, and
wherein the following inequalities are satisfied,
$$- 0.61 \leq f \times PL 2 \leq - 0 \text{.15}$$
$$15. 00 \leq vdL 45 \leq 27.50$$
where f represents a focal length of an entire system of the optical system, PL2 represents a Petzval sum of the second lens, and vdL45 represents an average value of Abbe numbers of the fourth lens and the fifth lens.

3. The optical system according to claim 1,
wherein the following inequality is satisfied,
$$- 0.28 \leq fSP / f \leq - 0.12$$
where fSP represents a focal length of an air lens located between the first lens unit and the second lens unit, fSP is obtained by the following formula,
$$fSP = \frac{1}{\frac{1 - NdL 4}{R 2 L 4} - \frac{1 - NdL 5}{R 1 L 5} + \frac{( 1 - NdL 4 ) \times ( 1 - NdL 5 ) \times TSP}{R 2 L 4 \times R 1 L 5}}$$
where NdL4 represents a refractive index of the fourth lens, NdL5 represents a refractive index of the fifth lens, R2L4 represents a curvature radius of an image-side lens surface of the fourth lens, R1L5 represents a curvature radius of an object-side lens surface of the fifth lens, and TSP represents an air gap between the first lens unit and the second lens unit on the optical axis.

4. The optical system according to claim 1, wherein the following inequality is satisfied,
$$0.18 \leq TSP / TD \leq 0.33$$
where TSP represents an interval on the optical axis between a lens surface closest to the image side of the first lens unit and a lens surface closest to the object side of the second lens unit and TD represents an interval on the optical axis between a lens surface closest to the object side of the optical system and a lens surface closest to the image side of the optical system in an infinity focus state.

5. The optical system according to claim 1, wherein the following inequality is satisfied,
$$0.72 \leq ( TB 1 + TB 2 ) / f \leq 1.12$$
where TB1 represents an interval on the optical axis from a lens surface closest to the object side to a lens surface closest to the image side of the first lens unit and TB2 represents an interval on the optical axis from a lens surface closest to the object side to a lens surface closest to the image side of the second lens unit the infinity focus state.

6. The optical system according to claim 1, wherein the condition is satisfied,
$$0.42 \leq Sk / f \leq 0.60 .$$
where Sk represents a back focus of the optical system.

7. The optical system according to claim 1, wherein the condition is satisfied,
$$1.77 \leq NdLp \leq 1.97$$
where NdLp represent an average value of refractive indices of all positive lenses included in the optical system.

8. The optical system according to claim 1, wherein the condition is satisfied,
$$- 3.10 \leq f \times P L 245 \leq - 2.21$$
where PL245 represents a Petzval sum of the second lens, the fourth lens, and the fifth lens and PL245 is obtained by the following formula,
$$PL 245 = \frac{1}{N d L 2 \times f L 2} + \frac{1}{N d L 4 \times f L 4} + \frac{1}{N d L 5 \times f L 5}$$
where NdL2 represents a refractive index of the second lens, NdL4 represent a refractive index of the fourth lens, NdL5 represents a refractive index of the fifth lens, fL2 represents a focal length of the second lens, fL4 represents a focal length of the fourth lens, and fL5 represents a focal length of the fifth lens.

9. The optical system according to claim 1,
wherein the second lens unit comprises, in order from the object side to the image side, a second-a lens unit and a second-b lens unit,
wherein, when focusing from an object at infinity to an object at a close distance, the first lens unit, the aperture stop, and the second-a lens unit integrally move on an optical axis, and the second-b lens unit does not move relative to an image plane for focusing.

10. The optical system according to claim 9, wherein the condition is satisfied,
$$0. 23 \leq fB 1 B 2 a / fB 2 b \leq 0.56$$
where fB1B2a represents a combined focal length of the first lens unit and the second-a lens unit and fB2b represents a focal length of the second-b lens unit.

11. The optical system according to claim 1, wherein the following inequality,
$$- 2.80 \leq S F L 2 \leq 0.62$$
where SFL2 represents a shape factor of the second lens and SFL2 is obtained by the following formula,
$$SFL 2 = ( R 2 L 2 + R 1 L 2 ) / ( R2L 2 - R 1 L 2 )$$
where R1L2 represents a curvature radius of an object side surface of the second lens and R2L2 represents a curvature radius of an image side surface of the second lens.

12. The optical system according to claim 1, wherein the following inequality is satisfied,
$$- 0.08 \leq S F L r \leq 4.55$$
where SFLr represents a shape factor of a rear lens disposed closest to the image side, and SFLr is obtained by the following formula,
$$SFLr = ( R 2 Lr + R 1 Lr ) / ( R 2 Lr - R 1 Lr )$$
where R1Lr represents a curvature radius of a lens surface on the object side of the rear lens and R2Lr represents a curvature radius of a lens surface on the image side of the rear lens is.

13. The optical system according to claim 1, wherein the following inequality is satisfied,
$$1. 50 \leq T L / f \leq 2.02$$
where TL represents a distance on the optical axis from a lens surface closest to the object side of the optical system to an image plane.

14. The optical system according to claim 1, wherein the condition is satisfied,
$$2.07 \leq f B 1 / f B 2 \leq 4.93$$
where fB1 represents a focal length of the first lens unit and fB2 represents a focal length of the second lens unit.

15. The optical system according to claim 1, wherein the first lens and the second lens are cemented to each other to form a cemented lens.

16. The optical system according to claim 15, wherein the cemented lens has an object-side surface having a convex shape and a meniscus shape having a positive refractive power.

17. The optical system according to claim 1, wherein the condition is satisfied,
$$0.31 \leq fL 1 L 2 / fB 1 \leq 1.98$$
where fL1L2 represents a combined focal length of the first lens and the second lens.

18. The optical system according to claim 1, wherein the fifth lens and the sixth lens are cemented to each other to form a cemented lens.

19. The optical system according to claim 1, wherein the following inequality is satisfied,
$$- 1.2 \leq f L 5 / f L 6 \leq - 0.64$$
where fL5 represents a focal length of the fifth lens and fL6 represents a focal length of the sixth lens.

20. The optical system according to claim 1, wherein the second lens unit comprises two or more positive lenses disposed on the image side of the sixth lens.

21. The optical system according to claim 1, wherein the following inequality is satisfied,
$$18. \leq ω \leq 32.$$
where ω represents a maximum half angle of view in degrees obtained by a paraxial calculation of the optical system in the infinity focus state.

22. The optical system according to claim 1, wherein the following inequality is satisfied,
$$Fno \leq 2.06$$
where Fno represents a F number of the optical system.

23. The optical system according to claim 1, wherein the following inequality is satisfied,
$$- 847 \leq D i \leq - 3.27$$
where Di represents a maximum value of a distortion amount under a central projection of the optical system.

24. An image pickup apparatus comprising: an optical system according; and an imaging element that picks up an image formed by the optical system,
wherein the optical system comprising, in order from an object side to an image side, a first lens unit having a positive refractive power, an aperture stop, and a second lens unit having a positive refractive power,
wherein the first lens unit comprises, in order from the object side to the image side, a first subunit and a second subunit,
wherein the first subunit comprises, in order from the object side to the image side, a first lens having a positive refractive power and a second lens having a negative refractive power,
wherein the second subunit comprises, in order from the object side to the image side, a third lens having a positive refractive power and a fourth lens having a negative refractive power,
wherein the second lens unit comprises, in order from the object side to the image side, a fifth lens having a negative refractive power, a sixth lens having a positive refractive power, and two or more lenses,
wherein a total number of lenses disposed in the optical system is 10 or less,
wherein a total number of lens units disposed in the optical system is two,
wherein a total number of subunits disposed in the first lens unit is two,
wherein a total number of lenses disposed in the second subunit is two,
wherein in an infinity focus state, an air gap on an optical axis between the first lens unit and the second lens unit is larger than a sum of air gaps between lenses included in the second lens unit,
wherein the following inequalities are satisfied,
$$- 1. \leq f \times P L 2 \leq - 0 \text{.15}$$
$$15. \leq v d L 45 \leq 32.00$$
where f represents a focal length of an entire system of the optical system, PL2 represents a Petzval sum of the second lens, and vdL45 represents an average value of Abbe numbers of the fourth lens and the fifth lens.
